(19) United States
(12) Patent Application Publication
(10) Pub. No.: US 2026/0329012 A1
(43) Pub. Date: Oct. 22, 2026

(54) MODULAR SYSTEM FOR OPTICAL ASSEMBLY AND CONNECTION TECHNOLOGY

(71) Applicant: Karlsruher Institut für Technologie, Karlsruhe (DE)

(72) Inventors: Patrick Schwaab, Weyher (DE); Christian Koos, Siegelsbach (DE); Matthias Worgull, Stutensee (DE); Pascal Maier, Karlsruhe (DE)

(73) Assignee: Karlsruher Institut für Technologie, Karlsruhe (DE)

(21) Appl. No.: 19/146,686

(22) PCT Filed: Jan. 11, 2024
(86) PCT No.: PCT/EP2024/050605

§ 371 Date: Jul. 9, 2025

(30) Foreign Application Priority Data
Jan. 12, 2023 (DE) 10 2023 200 214.0

(51) Int. Cl. G02B 6/36

(52) U.S. Cl. CPC G02B 6/366

(57) ABSTRACT

The invention relates to a micro-optomechanical system (10) and to a method for the production thereof. The micro-optomechanic al system (10) comprises: at least two carrier elements (40, 50), wherein each of the carrier elements (40, 50) has at least one connection element (20, 30), wherein each connection element (20, 30) is provided with at least one self-cetring joining element (300, 310, 320, 330) or is in the form of a self-centring joining element (300, 310, 320, 330), wherein the joining elements (300, 310, 320, 330) correspond with one another in such a way that the carrier elements (40, 50) are mechanically connected to one another by the joining elements (300, 310, 320, 330); and at least two optical components (60, 70), wherein each of the optical components (60, 70) is secured to one of the carrier elements (40, 50), wherein each of the optical components (60, 70) has at least one optical coupling point (80, 90), wherein at least one of the optical coupling points (80, 90) has a beam-shaping element (100, 110) created by a three-dimensional structuring method, and wherein there is an optical connection of the optical components (60, 70) at at least one optical coupling point (80, 90). In the micro-optomechanical system (10), micro-optical components can be precisely positioned and/ or adjusted with a high degree of design freedom within acceptable tolerances in the submicrometre range, in order to thereby provide individual functionality.

The present invention is located in the area of photonics and micro-optics and relates to a micro-optomechanical system and a method for its production. The micro-optomechanical system is preferably used as a modular system for optical assembly and connection technology.

### PRIOR ART

Optomechanical systems and methods for their production are known from the prior art. In the macroscopic size range, optical benches or optical tables have broad applications in greatly varying fields and offer a large variety of functions due to a large number of different usable optical components and easy adjustability.

However, simple and direct scaling to the microscopic size range cannot be performed proceeding therefrom. Micro-optomechanical systems are generally only developed and produced for a single special application due to their small dimensions. Readjustment is typically only possible with great effort. There is presently no solution in the microscopic size range by using which micro-optomechanical systems can be produced without long development effort, comparable to the assembly of an optical system on an optical table. The handling of the microscopic components plays a large role in this case, in particular since the functionality of micro-optomechanical systems is based on small tolerances and therefore components in the microscopic scale are not easy to position or adjust within acceptable tolerances in the submicrometer range, so that modifying an existing micro-optomechanical system for another use is generally not possible.

Wallrabe, U. ; Mohr, J. Modular Microoptical Systems for Sensors and Telecommunication. Sensors Update, 2003, vol. 12., no. 1, pp. 143-174 describe a coupling of micro-optical fibers and an assembly of components such as receivers or spectrometers.

Gerlach, A. ; Ziegler, P. ; Mohr, J. Assembly of hybrid integrated micro-optical modules using passive alignment with LIGA mounting elements and adhesive bonding techniques. Microsystem technologies, 2001, vol. 7, no. 1, pp. 27-31 describe an associated component as an example of a system designed for a single application, which cannot be readily modified or adapted to other requirements.

S. Schüle, U. Hollenbach, J. Mohr, J. Li, P. Vorreau, Modular integration of microactuators and micro-optical benches. In: Micro-Optics 2008. SPIE, 2008. pp. 11-22 describe the assembly of an interferometer by using the LIGA process, for which various optical components are assembled to form a system.

Kanty Rabenorosoa, Cédric Clĕvy, Sylwester Bargiel, Jean-Philippe Mascaro, Philippe Lutz, Christophe Gorecki, Modular and reconfigurable 3d micro-optical benches: concept, validation, and characterization. In: International Manufacturing Science and Engineering Conference. 2011. pp. 479-485 und S. Bargiel, K. Rabenorosoa, C. Clévy, C. Gorecki, P. Lutz, Towards micro-assembly of hybrid MOEMS components on a reconfigurable silicon free-space micro-optical bench. Journal of Micromechanics and Microengineering, 2010, vol. 20, no. 4, p. 045012 describe a mounting system for adjustable micro-optical components having a mechanical guide, which enables an alignment along the optical axes.

Tobias N. Ackermann, Jordi Vila-Planas, Xavier Muñoz-Berbel, Erica Álvarez-Conde, Daniel Kopp, Hans Zappe, Andreu Llobera, A toolbox for fast and simple assembly of a photonic lab on a chip. In: CLEO: Science and Innovations. Optica Publishing Group, 2016. p. SWIG. 3 describe how a microfluidic system can be modularly assembled and optically examined.

Pentti Karioja, Kimmo Keränen, Mikko Karppinen, Kari Kautio, Veli Heikkinen, Markku Lahti, Jyrki Ollila, Jukka Tapani, Mäkinen, Kari Kataja, Jarkko Tuominen, Tuomo Jaakola, Sang Hyun Park, Pentti Korhonen, Teemu Alajoki, Antti Tanskanen, Jaakko Lenkkeri, Juhani Heilala, LTCC toolbox for photonics integration. In: IMAPS/ACerS Int'l Conf. and Exhibition on Ceramic Interconnect and Ceramic Microsystems Technologies, CICMT. 2006. pp. 25-27 describe an assembly of a micro-optomechanical system from various layers of coated glass ceramic plates in which micro-optical components are integrated.

Norbert Keil, Crispin Zawadzki, Ziyang Zhang, Jin Wang, Nelson Mettbach, Norbert Grote, Martin Schell, Polymer PLC as an optical integration bench. In: Optical Fiber Communication Conference. Optica Publishing Group, 2011. p. OWMI describe a method for producing a micro-optomechanical system for beam splitting by using thin-film elements and trenches for mounting optical fibers. This method was expanded by using thin-film technology by Moritz Kleinert, David de Felipe, Crispin Zawadzki, Walter Brinker, Jung Han Choi, Photonic integrated devices and functions on hybrid polymer platform. In: Physics and Simulation of Optoelectronic Devices XXV. SPIE, 2017. pp. 220-230.

Yasuhiko Aoki, Toshio Kato, Rogerio Jun Mizuno, Kenichi Iga, Micro-optical bench for alignment-free optical coupling. Applied optics, 1999, vol. 38, no. 6, pp. 963-965 describe the possibility of coupling micro-optical components or systems.

Ulrich K. Gengenbach, Automatic assembly of micro-optical components. In: Microrobotics: Components and Applications. SPIE, 1996. pp. 141-150 describes problems in the automatic centering of micro-optical components.

In Carmelo Scarcella, Kamil Gradkowski, Lee Carroll, Jun-Su Lee, Matthieu Duperron, Daivid Fowler, Peter O'Brien, Pluggable single-mode fiber-array-to-PIC coupling using micro-lenses. IEEE Photonics Technology Letters, 2017, vol. 29, no. 22, pp. 1943-1946, the positioning accuracy of Lego bricks is used to optically couple two components.

DE 321 93 99 C2 discloses optical components which are aligned along an optical axis by using rods. A rod system is used here as the mount and guide, which cannot be used in the micrometer range in the described form.

DE 198 20 524 A1 discloses micro-optical components which are placed by using pins on a printed circuit board having a hole pattern. For this purpose, individual micro-optical components are produced separately from the mount and fastened on a plate having a hole pattern. Positioning and adjustment are restricted due to the hole pattern grid. Moreover, the micro-optical components have to be manually placed on the carrier plate.

US 2003/0231835 A1 discloses a possibility for fastening and aligning micro-optical components along an optical axis on a micro-optical bench. The foundation is an elongated mounting base for accommodating the micro-optical components. Curved outer surfaces of the mounting base are designed in this case so that they have the same outer contour as the optical components as a negative, so that the micro-optical components can be positioned by pairing on the mounting base.

DE 10 2005 050 274 A1 discloses a device for coupling beam guides of optical systems for unidirectional or bidirectional transmission of beams via a beam transition between the optical systems using a connecting device and mechanical centering means. A magnetic coupling to effectuate a coupling connection is provided here on the connecting device in a coupling area. The centering means are designed and arranged on the opposing optical systems to be coupled such that they cause self-centering of the beam guides upon the attraction caused by the magnetic forces.

WO 2013/010634 A1 discloses an optoelectronic module, in which optoelectronic components, in particular chips, are applied to a two-dimensional carrier. Such chip-on-board modules correspond to electrical assemblies which comprise at least one carrier and at least one unhoused semiconductor component mounted on the carrier. For the optical coupling, it is described herein how lenses for coupling and decoupling of light can be produced and attached there.

DE 10 2016 221 464 A1 discloses a system having optical components and their positioning and fixing on a common baseplate.

### Object of the Invention

Proceeding therefrom, the object of the present invention is to provide a micro-optical mechanical system and a method for its production which at least partially overcome the listed disadvantages and restrictions of the prior art.

In particular, the object of the present invention is to provide a method for producing a micro-optomechanical system, using which micro-optical components can be positioned and/or adjusted as precisely as possible with a high degree of design freedom within acceptable tolerances in the sub-micrometer range in order to provide a micro-optomechanical system having the greatest possible individual functionality. It would be desirable in this case if individual components of the micro-optomechanical system could be reproduced by using a three-dimensional structuring method, preferably in parallel in large quantities.

### Disclosure of the Invention

This object is achieved by a micro-optomechanical system and a method for its production having the features of the independent claims. Advantageous refinements, which are implementable individually or in any combination, are represented in the dependent claims and the following description.

In a first aspect, the present invention relates to a micro-optomechanical system which comprises:
at least two carrier elements, wherein each of the carrier elements has at least one connecting element, wherein each connecting element has at least one self-centering joining element or is designed as a self-centering joining element, wherein the joining elements fit with one another such that the carrier elements are mechanically connected to one another by using the joining elements; and
at least two optical components, wherein each of the optical components is fastened on one of the carrier elements, wherein each of the optical components has at least one optical coupling point, wherein at least one of the optical coupling points comprises at least one beamforming element produced by using a three-dimensional structuring method, and wherein an optical connection of the optical components is present at at least one optical coupling point.

According to the invention, at least two individual modules are connected to one another and therefore form the present micro-optomechanical system as a grouping, which is expandable as desired by connecting at least one further module. The concept of “module” refers in this case to a smallest unit which can no longer be decomposed into a smaller unit, without in this case losing the intended functionality with regard to a connection, in particular a joining or concatenation, of at least two individual modules. Each module comprises a carrier element which has at least one connecting element. For this purpose, the carrier element can have precisely one connecting element or preferably two, four, or also more connecting elements. The concept of “connecting element” refers to a micromechanical element which is configured to establish a mechanical connection to another carrier element, which is also equipped with a connecting element.

The concept of “joining element” refers in this case to a micromechanical element comprised by the connecting element, which enables the formation of the mechanical connection to the further module, by which orientation and relative position of the modules connected to one another is defined in relation to one another. The joining elements are designed such that they fit with one another so that the carrier elements are mechanically connectable to one another by using the joining elements. In a particularly preferred design, the joining elements can be mechanically connected to one another in a form-fitting manner by using a form fit thus achieved. In particular, the connecting element can be configured for a planar concatenation and/or stacking of self-centering joining elements fitting with one another and preferably identical to one another; another type of the formation of the mechanical connection between two modules is conceivable, however. For this purpose, a joining element of the same type or another type of joining element can be used in each case. In particular, the joining elements can be designed as fitting with one another such that they can structurally interlock, in particular as identical pairs and/or as a plug and coupling.

According to the invention, the joining elements are designed as self-centering joining elements. The term “self-centering” relates to a geometric property of the joining element which is directed to forming the mechanical connection of one module to another module along an intended mechanical axis. For this purpose, the self-centering joining element can be configured such that a further joining element attached thereon is changed in its position and orientation, for example by sliding and/or rotating, until the desired mechanical connection is formed by using the joining element along the intended mechanical axis. In addition, tapering structures and/or undercuts provided in the joining element can restrict a movement in at least one undercut direction and therefore can fix the defined position and orientation of the modules connected to one another. Rotational and translational degrees of freedom from a very large set of starting locations and starting orientations can be restricted by this type of mechanical connection in such a way that preferably a statically defined final position can result, the number of degrees of freedom of which is less than the number of degrees of freedom of the starting position. In particular, with a statically defined final position, all degrees of freedom can be restricted such that no translational and rotational movements are enabled. Other embodiments which permit selected rotational and/or translational degrees of freedom are possible, however. In this way, the modular character of the present micro-optomechanical system can be strengthened. In particular, at least one optical axis, in particular an optical axis which extends through an optical coupling point between modules of identical or different size and shape, can be uniquely defined by the same predetermined shape of the joining elements. Depending on the functionality of the participating modules, which depends in particular on the respective optical structure of the respective module, however, it can be advantageous to vary the shape and size of the participating modules, in particular the carrier elements and the joining elements comprised thereby, accordingly. A variation can relate in particular to the type, number, alignment, and/or orientation of the optical components and the associated optical coupling points. Alternatively or additionally, the variation can relate to a design of at least one stop or a marking, wherein preferably at least one vertical ramp or at least one step or at least one jointly used surface can be used as a stop, and wherein the marking can in particular comprise a measuring marker. Further details on the at least one stop or the marking are found in the following description.

In a particular embodiment, the micro-optomechanical system can furthermore have at least one further carrier element, on which none of the optical components is fastened and which does not comprise any of the beamforming elements. The at least one further carrier element can preferably be used as a spacer, to set a desired distance between at least two modules and/or at least two optical components, in particular to provide space for attaching at least one further component, preferably a further optical component, preferably on a surface extending beyond a base area of the at least one carrier element. A collimated light beam can preferably be used to bridge the distance. Other designs of the at least one further carrier element are conceivable, however.

Due to the precise arrangement of the carrier elements in relation to one another, the modules can be provided with optical components such that they are positioned and oriented aligned in relation to one another so that the individual modules can be optically coupled with one another by using a transmission of light. The concept of “positioning” refers in this case to an arrangement of an element at a point in three-dimensional space, while the concept of “orientation” relates to the alignment of the element at this point in the three-dimensional space. Electromagnetic radiation, which is usually only designated herein with the term “light” for simplicity, is not restricted to wavelengths λ in the visible optical range, λ=400 nm to 800 nm, however, but can comprise any type of electromagnetic radiation which can be guided in a waveguide. For this purpose, in addition to the electromagnetic radiation in the visible optical range, in particular also electromagnetic radiation from the ultraviolet range, λ=10 nm to 400 nm; the infrared range, λ=800 nm to 1 mm; the terahertz or millimeter wave range, λ=30 μm to 3 mm or λ=1 mm to 1 cm; and the microwave range, λ=1 mm to 1 m, can be suitable. In this case, the optical components can differ from one another in their design and/or mode of operation depending on the selected wavelength, even with identical functionality. Numeric values specified hereinafter, in particular for dimensions of structures or for the description of performance parameters of a three-dimensional microstructuring method, in particular for resolution or accuracy, relate, if not otherwise indicated, to arrangements which are configured for a vacuum operating wavelength λ of approximately 1.5 μm. For another operating wavelength, the specified numeric values can be scaled proportionally to the wavelength, in particular in consideration of the index of refraction of the materials used.

The concept of “optical component” refers to a structure on an element or an independent component which is configured for emission, transport, reception, detection, and/or manipulation of light, while the concept of “optomechanical system” refers to an arrangement of at least two optical components on at least two carrier elements. Preferably, each optical component used in the scope of the present invention is selected from the group comprising: optical glass fibers, in particular monomode fibers or multimode fibers made of organic or inorganic materials; integrated optical chips, in particular photodiodes, linear or planar photodiode arrays, CCD arrays or image sensors, in particular based on semiconductors, preferably silicon or III-V compound semiconductors, or dielectric materials, preferably glasses, silicon dioxide, silicon nitride, or polymers; bolometers; lasers, in particular surface-emitting lasers (vertical-cavity surface-emitting lasers, VCSEL) or edge-emitting lasers; superluminescent diodes; optical circuit boards; elements for free beam optics, in particular lenses, beam splitters, isolators, mirrors, or diffraction gratings. Other optical components are conceivable. The optical components can preferably comprise optical waveguides having low index contrast, in particular glass-based optical waveguides, or having moderate or high index contrast, in particular waveguides based on semiconductors or dielectric materials. Coupling or decoupling of light can preferably take place at an edge or on a surface of the optical component; in particular at an edge of an edge-emitting laser, at a chip edge, or at a facet of a waveguide-based system; alternatively at a surface of a surface-emitting laser or a surface-illuminated photodiode, or on the surface of a waveguide-based chip, which has at least one optical coupling point, in particular comprising an optical grating coupler or an optical deflection element. However, other types of coupling or decoupling of light are possible.

The concept of “optical waveguide” refers to any arrangement which is configured to guide an electromagnetic wave, in particular in the wavelength range specified above. These preferably include individual optical waveguides, optical waveguides having branches, polarization filters, polarization beam splitters, polarization converters, tapers, directional couplers, couplers based on multimode interference (MMI), waveguide networks, and waveguide-based structural elements, also in combination with micro-optical elements such as lenses, mirrors, or prisms. However, other types of optical waveguides are conceivable. The guiding of the electromagnetic wave in the optical waveguide can take place in this case in particular by using total reflection at an optical boundary surface or by using multiple reflection at periodically arranged elements, for example in the case of an optical waveguide based on a photonic bandgap or on a photonic crystal. In more complex optical waveguides, for example in so-called “sub-wavelength grating waveguides”, abbreviated “SWG”, the wave guiding is based on an index of refraction which is effectively increased in the area of the waveguide core. The wave guiding by using optical waveguides is based in this case on the fact that in contrast to a propagation of the light in free space, the divergence of the light propagating in the optical waveguide in the lateral direction is prevented by a continuous interaction of the light with dielectric boundary surfaces or, in the case of a tapering or expanding optical waveguide, is controlled. It is thus possible to guide light in an area elongated in the propagation direction in the axial direction, wherein the ratio of the axial extension of the light-filled area is preferably greater than 3, particularly preferably greater than 5, and very particularly preferably greater than 10 or 20. In addition to the at least one optical waveguide, the optical component can have further optical structures, in particular selected from at least one refractive, diffractive, and/or reflective optical element, for example at least one lens or one mirror, which are configured to additionally change the propagation of the electromagnetic radiation in the optical component.

In a preferred embodiment, the optical waveguide can have a layer thickness, for a vacuum operating wavelength of approximately 1.5 μm, preferably of 10 nm to 1000 nm, particularly preferably of 30 nm to 500 nm, in particular of 50 nm to 300 nm, applied to one of the optical components or to one of the carrier elements. It is therefore possible in particular to produce the at least one optical waveguide having deviations of less than 1000 nm, particularly preferably less than 500 nm, in particular less than 100 nm. The resolution of a three-dimensional structuring method can in this case preferably be better than 3 μm, particularly preferably better than 1 μm, in particular better than 500 nm. In particular with respect to a replication effectuated by a three-dimensional structuring method, the resolution can deviate less than 3%, particularly preferably less than 2%, in particular less than 1% from the original formation to be replicated, with respect to an inaccuracy and/or tolerance in the production. The above-mentioned numeric values relate to the production of an optical waveguide which is intended for a vacuum operating wavelength of approximately 1.5 μm. For other operating frequencies, the dimensions of the at least one optical waveguide and therefore the requirements for accuracy and resolution of the three-dimensional structuring method used for production can be scaled accordingly, possibly in consideration of the index of refraction of the materials used.

Each module of the present micro-optomechanical system furthermore comprises at least one optical component, which is fastened on an associated carrier element. For this purpose, the carrier element can have at least one receptacle element for at least one component to be accommodated, in particular an optical component and/or electronic component to be accommodated. The concept of “receptacle element” refers to a micromechanical element which is configured to establish a mechanical connection between an element and at least one component to be accommodated thereby, in particular between at least one carrier element and the at least one optical component and/or electronic component, but also between at least one carrier element and at least one carrier plane, between at least two carrier planes, or between at least one carrier plane and at least one optical component and/or electronic component. The mechanical connection can relate in this case in particular to a planar concatenation and/or a stack. In a preferred embodiment, at least one stop can be used for this purpose, wherein preferably at least one vertical ramp or at least one step or at least one commonly used surface can be used as the stop, in particular to define a vertical position or a horizontal position between the element and the at least one component to be accommodated thereby. Alternatively or additionally, the carrier element can comprise at least one component introduced into a volume of the carrier element and/or applied directly to a surface of the carrier element, which can be designed in particular as a beamforming element and/or as a receptacle element and/or as a positioning element. The concept of “electronic component” refers in this case to an independent component which is configured for the transport and/or the manipulation of current. In particular an electronic component which is selected from an electrical conductor track, an electronic chip, an integrated circuit, an electrical voltage source, an electrical resistor, an electrical capacitor, an electrical coil, an electrical diode, an electrical transistor, or a sensor is suitable for the present invention; however, a use of at least one other electronic component is possible.

In a preferred embodiment, size and shape of the receptacle elements can correspond to the same specifications as for the joining elements. The at least one receptacle element can preferably be designed as a self-centering receptacle element and in this case in particular can be adapted to the at least one component to be accommodated, in particular the at least one optical component and/or electronic component to be accommodated. The at least one receptacle element can be detachably or non-detachably connected to the at least one component to be accommodated after completed accommodation. The accommodation can take place as a planar concatenation and/or as a stack. In a particular embodiment, the at least one receptacle element can be equipped with at least one undercut, in particular to connect the at least one component to be accommodated detachably or non-detachably to the receptacle element. In a particular embodiment, an optical component, which is not fastened by using at least one receptacle element on the associated carrier element, can preferably be produced by using a three-dimensional structuring method on and/or in the carrier element. Alternatively or additionally, an optical component which is not fastened by using at least one receptacle element on the associated carrier element can be produced together with the carrier element by using a three-dimensional structuring method, preferably integrated in the volume of the carrier element in one step. In this embodiment, these elements can be designed as contiguous three-dimensional structures, replicated in a shape memory material, and/or produced by using a three-dimensional structuring method. However, other methods for producing the elements are possible.

In a further particular embodiment, at least one optical component can be used as an insertable optical component, which is arranged on or at the carrier element by using a preferably tapering mount for positioning and/or orientation, which can in particular have undercuts. In this case, the receptacle element on the carrier element can be aligned on the at least one optical component such that it connects the relevant module along the optical axis to the further module to be connected, wherein in this way the desired optical coupling occurs.

In a further particular embodiment, in particular for use in medical technology or biosensors, the micro-optomechanical system, preferably at least one of the carrier elements, can comprise at least one fluid-guiding component, which can be equipped with a receptacle element. The modules can be designed such that at least one component, in particular an optical component and/or electronic component, can be inserted into the beam path and in this way incident light can be manipulated and/or guided, coupled into at least one component, and/or studied for a change with respect to the transmission. Further applications are possible, in particular in data transmission.

In a further particular embodiment, the micro-optomechanical system, preferably at least one of the carrier elements, can comprise at least one thermoelectric component, in particular a heating element or a Peltier element.

In a preferred embodiment, the micro-optomechanical system can comprise at least one material which can be thermally stable or at least thermally loadable, preferably up to a temperature of 350 °C, particularly preferably up to 200 °C, in particular up to 100 °C. The thermal expansion of materials having different coefficients of expansion can be taken into consideration in the configuration of components of the micro-optomechanical system, in particular for compensation of thermally related tolerance changes, preferably by using at least one elastically re-adjustable receptacle element and/or positioning element, which can preferably be provided in the form of a clamping element.

According to the invention, each of the optical components has at least one optical coupling point. The concept of “optical coupling point” refers to a spatial point at which a connection occurs by using light between two optical components which, depending on the beam path, can be referred to as the “light-emitting component” and as the “light-receiving component”. The optical coupling point is therefore configured to connect two optical components via an optical axis generated by the at least two optical components connected to one another such that an optical coupling of the modules takes place, which each comprise one of the two optical components connected to one another.

In the present micro-optomechanical system, at least one of the optical coupling points comprises a beamforming element produced by using a three-dimensional structuring method. The beamforming element is configured to manipulate the light so that it can be coupled from the optical assembly of a first module into a second module. The terms “first”, “second”, etc. are viewed here as a description of an element without defining a sequence, assessment, or chronological order and without excluding the possibility that other elements of the same element can be present. Furthermore, the concept of “three-dimensional structuring method” refers to a micro-lithographic method for producing microstructures in three-dimensional form. In particular a three-dimensional structuring method which is selected from micro-3D printing, in particular stereolithography (SLA), two-photon polymerization (2PP or TPP), fused deposition modeling (FDM), or projection micro-stereolithography (PSL); or a method for replication, in particular hot embossing, micro-injection molding, or a three-dimensional replication method by using a shape memory effect; an etching method, or a deposition method is suitable for the present invention. The shape memory effect can be used in the production and/or in downstream method steps, above all to reestablish the original shape and location in spite of small deformations or minor subsequent damage.

At least one further component or subcomponent can also be produced by using at least one micro-lithographic method, in particular by using the three-dimensional structuring method described herein. A module can preferably be replicated in a polymer, very preferably in a shape memory polymer. If thermoplastic shape memory polymers are used, contiguous three-dimensional structures having undercuts can be replicated easily. This is also the case with the use of elastic molding tools in combination with liquid UV resists. A design which can be replicated can preferably be selected for fabrication by a three-dimensional structuring method. To reduce postprocessing, mounting tolerances, and joining tolerances and to shorten the production process, it can be advantageous to integrate as many functions and components of the optical assembly as possible into a carrier element and to produce them together with the carrier element in a common method.

In a particular embodiment, in a three-dimensional structuring method, a residual carrier layer, on which parts to be replicated are located, can preferably be removed, in particular so that the carrier elements have the same height and therefore an identical location of the optical axis. For this purpose, the residual carrier layer can preferably be removed by using a method selected from a machining method, etching, or dissolving, preferably in an upside down mount, in order to achieve better accessibility. Alternatively, a residual carrier layer having defined height can remain standing, in particular so that the carrier elements and/or carrier planes have the same height and therefore an identical location of the optical axis. It can be advantageous in this case to remove the residual carrier layer at at least one edge of one of the carrier elements. The carrier element and/or the carrier plane and/or the connecting element and/or the receptacle element can preferably be designed such that it has an at least partially linear cut edge, which can preferably moreover be accessible as well as possible.

The optical components are placed in this case on and/or at and/or in the at least two carrier elements such that an optical connection of the optical components exists at at least one optical coupling point. For this purpose, in particular the at least one beamforming element, together with the at least one joining element of a carrier element of a first module, can be optically coupled with at least one joining element fitted thereto, at least one optical element, and an optionally provided beamforming element of a carrier element of a second module. The beam path of the optical connection can in particular have the following sections:
i. a beam-expanding section, which is distinguished in that the beam diameter increases in this section. The beam-expanding section can use the natural divergence of the light field emerging from the optical component and/or can modify the light field by a sub-element of the beamforming element. The divergence can in particular be enlarged by using concave lenses, convex mirrors, or diffractive elements, which are produced by using a three-dimensional structuring method. A further possibility for beam expansion can comprise a production of an optical waveguide which initially shrinks the mode field diameter. Upon subsequent propagation of the beam outside the optical component in free space, a high divergence can result. The divergence of the light beam in the beam-expanding section and/or an imaginary continuation of the light beam in a far field can preferably be at most 6°, particularly preferably at most 15°, in particular at most 30°, each defined as half the opening angle in relation to an intensity of 13.5% of the maximum intensity.
ii. a collimated section, which is distinguished in that the beam diameter only changes slightly in this section. In a transition area between the beam-expanding section and the collimated expanded section, a collimating optical element can preferably be inserted, for example a concave mirror or a convex lens. A beam waist can form in this case, for example. The “beam waist” can be located here at a position of a Gaussian beam or a Gaussian-like beam, at which an essentially planar phase front occurs. The size of the beam waist, i.e. the waist diameter, can adopt here, at a wavelength of 1550 nm, preferably a value of 5 μm to 100 μm, particularly preferably of 10 μm to 80 μm, in particular of 15 μm to 50 μm. The associated beam divergence in relation to half the opening angle results from relevant formulas for Gaussian beams and is preferably at most 12°, particularly preferably at most 6°, in particular at most 4°. At wavelengths above or below 1550 nm, these values can change accordingly. The field distribution generated by the beamforming element can preferably correspond as well as possible to the field distribution which is coupled into one of the optical components.
iii. a beam-constricting section, which is distinguished in that the beam diameter decreases again here. The design of the beam-constricting section can take place in this case analogously to the measures which are described under point i. for the beam-expanding section.

In a particular embodiment of the present micro-optomechanical system, at least one of the carrier elements, preferably all participating carrier elements, can be fastened on at least one carrier plane, preferably on precisely one carrier plane. For this purpose, the at least one carrier plane can be configured in particular for further positioning and/or orientation of individual modules or modules connected to one another, which are also referred to here as a “module group”. Receptacle elements, in particular tapering receptacle elements, which can in particular have at least one undercut for fixing, can be used for the positioning and/or orientation. The receptacle elements can be designed such that they permit a movement of the carrier elements on the carrier plane and/or the carrier plane on a further carrier plane, preferably a one-dimensional translational movement. The arrangement of adjacent modules and/or modules on the carrier plane can take place in a planar flat manner or vertically, rotated by 180° upside down. Positioning and receptacle elements configured for arranging the modules can be provided in this case on the upper side of the modules and/or module groups and/or the at least one carrier plane. In this embodiment, the lower side of the at least one carrier element or, in the case of upside-down mounting, the upper side of at least one inverted carrier element, and the upper side of the at least one carrier plane can preferably have the same height. In this way, it can be possible to define a height level for the optical axis for connecting the modules. If a height offset of the optical axis occurs, for example due to a further carrier plane or due to a height difference in the optical assembly, between carrier elements or carrier planes, the height offset of the optical axis can thus be compensated for by using adapted module height, adapted height of the optical assembly, by using beamforming elements, receptacle elements, mounts, and/or plateaus arranged at different heights, and/or by using at least one further carrier plane. Carrier planes can in this case comprise predefined receptacle elements for attaching at least one further carrier plane, the functionality of which can preferably correspond to the joining elements. Furthermore, the positioning and/or receptacle elements can also be used for protection and/or as spacers of the optical components.

In a particular embodiment, at least one of the joining elements and/or the receptacle elements can be designed as a positioning element and/or can have at least one positioning element, which can be configured during a production of the micro-optomechanical system for the purpose of bringing the components to be mounted as directly as possible into their final position, in that predefined positioning elements are predetermined, from which the final position can result by a rotational and/or translational movement. A very precise final position of each module which is precisely defined in three dimensions can be set therefrom in the micro-optomechanical system to an accuracy at a level of a desired positioning tolerance, in particular at a level of 1 dB, as precisely as possible in relation to one another. The 1 dB positioning tolerance describes a threshold of coupling losses of 1 dB between two optical components, caused by an alignment position at the optical coupling point, in particular with respect to lateral deviations of a beam profile, lateral deviations in relation to the optical coupling point, angle deviations and/or collimation errors, absorption losses, reflection losses, scattering losses, in particular due to Rayleigh scattering. The alignment precision results from the sum of all tolerance-related individual deviations, typically comprising manufacturing tolerances, mounting tolerances, and environmental tolerances, in particular due to vibrations or magnetism or due to temperature, humidity, or air pressure of the environment. The smallest beam diameter occurring at the optical coupling point between two optical components can preferably be two times, particularly preferably five times, in particular more than 10 times the alignment position. In this case, the beam diameter occurring at the optical coupling point between two optical components can preferably be 1 μm to 10 mm, particularly preferably 5 μm to 1 mm, more preferably 10 μm to 200 μm, in particular 15 μm to 100 μm. The concept of “beam diameter” refers in this case to a diameter, measured perpendicularly to the propagation direction of the light beam, of a region in which the intensity of the light is greater than 1/e², i.e. greater than 13.5% of the maximum intensity, which typically occurs on the beam axis. Alternatively, the concept of “beam diameter” can relate to a full width at half maximum (FWHM) or a fourfold standard deviation of the intensity distribution (D40 width). As an example, at a beam diameter of 50 μm, a required alignment position of the optical coupling point of at least 25 μm, particularly preferably of at least 10 μm, in particular of at least 5 μm results. A use and/or a usage environment of the optical components can also be taken into consideration in this case, in particular a thermal expansion upon a use of materials having different coefficients of thermal expansion. The mechanical positioning tolerance of the connecting elements results from the 1 dB positioning tolerance. The concept of “tolerance” refers to a deviation of an actual state from a target state, or an actual variable from a target variable. Shape and location deviations result due to manufacturing and mounting. The concept of “tolerance” refers in this case to a tolerance chain up to the respective point in the product creation chain, which results from a sum of all manufacturing and mounting tolerances upstream with respect to time and space. Due to these deviations, differences result between the actual position of optical axes and/or optical coupling points and the target position with the least possible transmission losses.

A positioning element can preferably be used for this purpose, the shape of which is produced together with the optical component and which is embodied such that a point, line, and/or surface, which is produced on, at, or in the optical component or is already present, for positioning in the form of a stop, the optical component is precisely positioned while maintaining the desired positioning tolerance, wherein the shape is producible by using a method selected from forming methods such as etching, deep etching, or machining methods or from casting methods, wherein the point, line, and/or surface are predetermined. The use of at least one other shaping production method is possible, however. The design of the optical assembly can be matched here to the position and/or orientation of the component to be joined, in particular if preferred orientations for the positioning and/or orientation exist. In particular, components to be joined can be attached lying normally or upside down.

The carrier elements connected to one another, the carrier element having the at least one carrier plane and/or the at least two carrier planes can be detachably connected to one another while maintaining shape and functionality and can thus be employed later for a further use of the micro-optomechanical system. Alternatively, the carrier elements connected to one another, the carrier element having the at least one carrier plane and/or the at least two carrier planes, in particular depending on the structure and use of the micro-optomechanical system, can be non-detachably connected to one another while maintaining shape and functionality in order to obtain the relevant micro-optomechanical system in a particularly stable manner.

The functionality of a module or a module group can depend in particular on the respective optical assembly. The size of a module, which is preferably adapted thereto, can deviate from a preferred standard size of less than 100 cm², particularly preferably at most 20 cm², and very particularly preferably at most 5cm², in particular at most 2 cm², as long as the optical axes of two modules joined to one another correspond. In a preferred embodiment, the outer edges can be perpendicular; alternatively, they can have an angle in relation to one another different from 90°, however. In a particular embodiment, individual modules can deviate from a preferably rectangular shape, in which the longest planar edge length is preferably equal to or an integer multiple of the shortest planar edge length, in particular if two modules are connected at a defined angle, which can preferably be embodied by a shape deviation of the base area of the carrier element in the form of a triangle, trapezoid, parallelogram, or a combination thereof. Furthermore, the size of a module can be increased or reduced by an amount by which the module to be produced can grow or shrink during the production, in particular upon application of an overexposure in a DLP printing process (Digital Light Processing), due to voxel-related size of the smallest writing unit in a 2PP printing process, or due to shrinking. The optical components are or become placed on the carrier element by using at least one receptacle element such that by combination of the joining elements of the at least one carrier element of a first module with the matching joining elements and the at least one beamforming element of a second module, an optical coupling is achieved. The size of a module can therefore also deviate from the preferred standard size, as long as the optical coupling point of two modules is clearly defined via the joining of the joining elements to one another.

In a further embodiment, a single module, a module group, or an entire micro-optomechanical system can be filled with a solid optically transparent medium, in particular to protect the micro-optomechanical system or a part thereof from external influences, against mechanical displacement of components aligned in relation to one another, or against deforming, to facilitate the handling, to generate an index contrast, to form a further coupling point for mounting at least one further element, to increase transmission, or to avoid reflections or undesired decoupling. The concept “transparent” refers in this case to an optical property of a material leading through electromagnetic waves such that the absorption by the material is as low as possible. The material absorption of the material is preferably less than 10 dB/mm, particularly preferably less than 5 dB/mm, and very particularly preferably less than 2 dB/mm or 1 dB/mm.

In a further particular embodiment of the present micro-optomechanical system, at least one of the carrier elements and/or at least one carrier plane can preferably be provided with at least one metallic layer, which is designed as at least one electrical conductor track. The at least one electrical conductor track can in particular be configured for electrically contacting at least one optical component. The at least one electrical conductor track itself can be connected for this purpose to the at least one optical component, the at least one electronic component, and/or to at least one external terminal, which can preferably be designed as a contact pad and which can preferably be configured to supply electrical energy and/or to discharge information, in particular in the form of at least one bond, preferably at least one wire bond. In particular, two carrier elements, two carrier planes, or one carrier element and one carrier plane can be connected to one another in the form of a bond, preferably a wire bond. Other embodiments of the at least one electrical conductor track are possible, however. The conductor tracks can be produced by using a mask. Preferably, an adhesive layer, which preferably comprises a material having good adhesion, in particular chromium, and then a starting layer for subsequent electroplating, which preferably comprises a metal having good electrical conductivity, in particular gold, can be applied. To carry out the electroplating, the conductor tracks can be applied in a galvanic bath to the desired layer thickness, which can depend in particular on the cross-section of the conductor tracks, and the applied amperage and voltage. Alternatively or additionally, conductor tracks can be applied by using a micro-structuring method, preferably by using micro-laser sintering, directly to a carrier element or a carrier plane.

In a further embodiment, at least one of the carrier elements and/or a carrier plane can have recesses and/or openings to enable accessibility to the optical assembly of optical components and/or electrical components. The recesses and/or openings can be designed in this case such that contactless mounting of the components to be joined is ensured and/or that the at least one carrier element and/or the carrier plane can only rest partially. This embodiment can furthermore have a placement unit on the upper side of the at least one carrier element to enable a placement of components upside down and/or to provide accessibility from the lower side.

The present micro-optomechanical system differs from the disclosure in DE 10 2016 221 464 A1, in particular from the system shown in FIG. 22, in that therein the surrounding medium is primarily used to reduce an index of refraction contrast or to set a precise distance between the optical components. In FIG. 22, two chips having beamforming elements are provided, which are embedded in a surrounding medium, while the alignment structures shown therein are located directly in the surrounding medium, which completely surrounds the optical components. In contrast, in the present micro-optomechanical system, there is no requirement for a surrounding medium. In the present micro-optomechanical system, each carrier element has a connecting element, which in turn has a self-centering joining element or is designed as a self-centering joining element. By a combination of connecting elements fitting with one another, which are moreover designed as joining elements, it is possible for a final position to be determined solely on the basis of the shape, and to be achieved solely by the joining procedure of two carrier elements. In contrast, the alignment structures shown by way of example in DE 10 2016 221 464 A1 are not joining elements, which readily hold the subsystems in position and result in a statically defined final position. Finally, it is not necessary in the present micro-optomechanical system for the fixing of the optical components to take place on a common base plate, since the position of the carrier elements automatically results due to the joining procedure of the self-centering joining elements, which are seated on the carrier elements.

In a further aspect, the present invention relates to a method for producing a micro-optomechanical system, which comprises the following steps:
a) providing at least two carrier elements, wherein each of the carrier elements has at least one connecting element, wherein each connecting element has at least one self-centering joining element, wherein the joining elements fit with one another such that the carrier elements are mechanically connectable to one another by using the joining elements;
b) providing at least two optical components, wherein each of the optical components has at least one optical coupling point;
c) producing at least one beamforming element at at least one of the optical coupling points by using a three-dimensional structuring method;
d) fastening each optical component on one of the carrier elements; and
e) establishing an optical coupling of the optical components at at least one optical coupling point by using a mechanical connection of the carrier elements by the self-centering joining elements fitting with one another.

Steps a) to e) according to the invention can preferably be carried out in the indicated sequence, wherein a deviating sequence, in particular carrying out step d) before step c), is also possible, however. In addition, steps can also be carried out at least partially simultaneously and/or further steps can be carried out, independently of whether or not they are described herein.

For details with respect to the present method for producing a micro-optomechanical system, reference is made to the rest of the description of the micro-optomechanical system. In particular, particular embodiments described therein are also producible using the present method.

The terms “having”, “including”, “comprising”, or “incorporating” or any grammatical deviations thereof are used in a nonexclusive manner herein. Accordingly, these terms can relate both to situations in which, in addition to the features introduced by these terms, no further features are present, or to situations in which one or more further features are present. For example, the expression “A has B”, “A includes B”, “A comprises B”, or “A incorporates B” can refer both to situations in which, except for B, no further element is present in A (i.e. to a situation in which A exclusively consists of B), and to the situation in which, in addition to B, one or more further elements are present in A, for example element C, elements C and D, or even further elements.

Furthermore, it is to be noted that the terms “at least one” and “one or more” and grammatical modifications of these terms, when they are used in conjunction with one or more elements or features, are to express that the element or feature can be provided once or multiple times, in general is only used once, for example upon the initial introduction of the feature or element. Upon a subsequent further mention of the feature or element, the corresponding term “at least one” or “one or more” is generally no longer used, without restriction of the possibility that the future or element can be provided once or multiple times.

Furthermore, the terms “preferably”, “in particular”, “for example”, or similar terms are used in conjunction with optional features without alternative embodiments being restricted in this way. Features which are introduced by these terms are thus optional features and it is not intended that these features restrict the scope of protection of the claims and in particular the independent claims. The invention can thus also be carried out using other embodiments, as will be recognized by a person skilled in the art. In a similar manner, features which are introduced by “in one embodiment of the invention” or by “in one exemplary embodiment of the invention” are understood as optional features, without there being any intention to restrict alternative embodiments or the scope of protection of the independent claims in this way. Furthermore, all possibilities of combining the features introduced in this way with other features, whether optional or non-optional features, are to remain untouched by these introductory expressions.

### Advantages of the Invention

The micro-optomechanical system described herein relates to a modular arrangement of micro-optical components and micromechanical components, which can preferably be at least partially produced by a three-dimensional structuring method of three-dimensional structures which are contiguous in a simple manner. A “three-dimensional structure which is contiguous in a simple manner” is understood as a structure which, in consideration of manufacturing-related deviations, in particular in areas traversed by light, does not comprise closed cavities, ring structures, or tunnel structures.

Each module in this case comprises two parts, on the one hand a carrier element which can be connected via at least one connecting element to at least one other carrier element, and on the other hand an optical component, which in particular has at least one optical waveguide and can comprise at least one receptacle element for accommodating, positioning, and orientation for at least one further optical component. The micro-optomechanical system can be configured in particular to transmit light between various optical components and manipulate this light. The functionality and efficiency of the at least two modules connected in the micro-optomechanical system is decisively dependent on a positioning tolerance of the carrier elements, including the optical components fastened thereon, which each together form the relevant module.

To achieve the best possible functionality and high-efficiency of a micro-optomechanical system, which comprises a plurality of modules, sufficiently small individual tolerances in the individual modules are necessary due to a tolerance chain. The tolerance chain comprises in this case in particular manufacturing-related and mounting-related variations as the sum of all uncertainties to be assumed, above all manufacturing tolerances of the carrier elements, including the joining elements comprised thereby, joining tolerances of the connection between the carrier elements, manufacturing tolerances of the optical components, and/or positioning tolerances of the optical components in relation to the respective carrier element, on which they are each fastened.

The micro-optomechanical system according to the invention proposed herein is preferably used as a modular system for optical assembly and connection technology and is preferably produced from prefinished modules, which connects a positioning functionality of an optical table to the optical functionality of optical components arranged thereon. Positioning and/or adjusting the optical components in the microscopic scale within an acceptable tolerance field in the submicrometer range is thus enabled. For this purpose, the individual optical components are predetermined in their location oriented in relation to one another and are preferably only displaceable along the optical axis, particularly preferably are unchangeable, for which a standardized basis having defined distances to one another, on which the optical components can be laid out, is provided. Micro-optomechanical systems of various functionalities can be produced by various concatenable optical components. For this purpose, predefined joining elements are used, which define position and orientation of the carrier elements and therefore optical components fastened thereon. Furthermore, a use of a three-dimensional micro-structuring method can produce functionally-relevant structures, on the one hand very precisely with respect to their shape and functionality, and on the other hand with a high degree of design freedom. Furthermore, the modules can preferably be duplicated by using a three-dimensional structuring method in parallel in large quantities in the case of structures which are contiguous in a simple manner.

No micro-optomechanical system which offers a mutual and universal functionality with regard to positioning and orientation, as provided by optical benches or optical tables in the macroscopic size range, is known from the prior art. Simple scaling down from the macroscopic range is not possible, in particular since the microscopic components cannot be easily handled, placed, oriented, and readjusted. For this reason, up to this point micro-optomechanical systems have been separately developed, produced, and assembled for each individual case.

In contrast to the present invention, DE 10 2016 221 464 A1 in particular does not disclose predefined optical coupling points or separate mechanical connections for mutual positioning of optical components. Furthermore, prefinished units are not presented therein, which can be pre-produced and in particular are configured so that they mutually complete one another upon simple connection, in particular concatenation, clicking together, or plugging together. The possibility of producing predefined, positioning, in particular three-dimensional micro-optomechanical structures including the carrier elements in one method step also does not exist therein. Furthermore, the beamforming elements do not necessarily have to be directly connected to the optical components therein.

In contrast, it is proposed according to the invention that the most uniform possible platform having predefined mechanical coupling points and optical coupling points matched thereto be provided, which exert a mutual centering and aligning function. Standards for optical couplings between greatly varying optical components have not been known up to this point. The invention presented here enables a micro-optomechanical system to be assembled by simple concatenation, clicking together, or plugging together with ultrahigh precision in the submicrometer range.

Furthermore, by selection of a shape memory material as a material, a “self-repairing” effect of the micro-optomechanical system or individual modules can be enabled. By way of this selection of the material in combination with a structure which is contiguous in a simple manner, it is moreover possible to produce the modules in parallel in large quantities by three-dimensional structuring methods, in particular with an optical axis lying perpendicular to the demolding direction.

### BRIEF DESCRIPTION OF THE FIGURES

Further details and features of the present invention result from the following description of preferred exemplary embodiments, in particular in conjunction with the dependent claims. The respective features can be implemented alone or in groups in combination with one another in this case. The invention is not restricted to the exemplary embodiments. The exemplary embodiments are schematically shown in the following figures. Identical reference signs in the figures designate identical or functionally-identical elements or elements corresponding to one another with respect to their functions in this case. In the specific figures:

FIG. 1 shows a schematic representation of an exemplary embodiment of a micro-optomechanical system according to the present invention in a top view (FIGS. 1a und 1b) and in a side view (FIG. 1c);

FIG. 2 shows a schematic representation of a possible optical assembly as an embodiment of a module according to the present invention in a perspective view;

FIG. 3 shows a preferred embodiment of a module in a schematic representation, comprising a self-centering receptacle element configured to accommodate cylindrical objects in a perspective view;

FIG. 4 shows a schematic representation of a further exemplary embodiment of the micro-optomechanical system according to the present invention in a top view;

FIG. 5 shows a schematic representation of a further exemplary embodiment of the micro-optomechanical system according to the present invention in a top view;

FIG. 6 shows a schematic representation of an exemplary embodiment for an application of a module, which is not yet equipped with an optical component, to a carrier plane in a perspective view;

FIG. 7 shows schematic perspective views of exemplary embodiments of self-centering joining elements on the carrier elements on modules;

FIG. 8 shows a detail view of two joined elements in a sectional view;

FIG. 9 shows two schematic representations of further exemplary embodiments of a module according to the present invention in a perspective view;

FIG. 10 shows a schematic representation of a detail view of the exemplary embodiment from FIG. 9a in a perspective view;

FIG. 11 shows two schematic representations of further exemplary embodiments of a module according to the present invention in a perspective view;

FIG. 12 shows four schematic representations of the modular principle with differently positioned optical axes;

FIG. 13 shows three schematic representations of further exemplary embodiments of a module according to the present invention in a top view (FIGS. 13a and 13b) and in a perspective view (FIG. 13c);

FIG. 14 shows three schematic representations, on the one hand as an exemplary embodiment of a replicated module directly after a replication procedure (FIG. 14a) and on the other hand a processing device for removing a residual carrier layer, in perspective (FIG. 14b) and as a section (FIG. 14c);

FIG. 15 shows a schematic design of a module, which has a carrier element that is configured to accommodate three components;

FIG. 16 shows a schematic design of a module for optically coupling two optical components;

FIG. 17 shows a schematic design of the micro-optomechanical system for coupling two chips (FIG. 17a) and a schematic design of the module (FIG. 17b) shown in FIG. 17a, both in a perspective view;

FIG. 18 shows a schematic representation of a further exemplary embodiment of the micro-optomechanical system according to the present invention in a top view;

FIG. 19 shows a schematic representation of a section through an optical element positioned in a joining device;

FIG. 20 shows a schematic design of a micro-optical system in a top view;

FIG. 21 shows the micro-optical system schematically shown in FIG. 13a, schematically expanded by using a spatially separated carrier unit and having a further beamforming element;

FIG. 22 shows schematic representations of an optical assembly as a design of a module in a perspective view; and

FIG. 23 shows a further schematic design of a micro-optical system in various representations.

### DESCRIPTION OF THE EXEMPLARY EMBODIMENTS

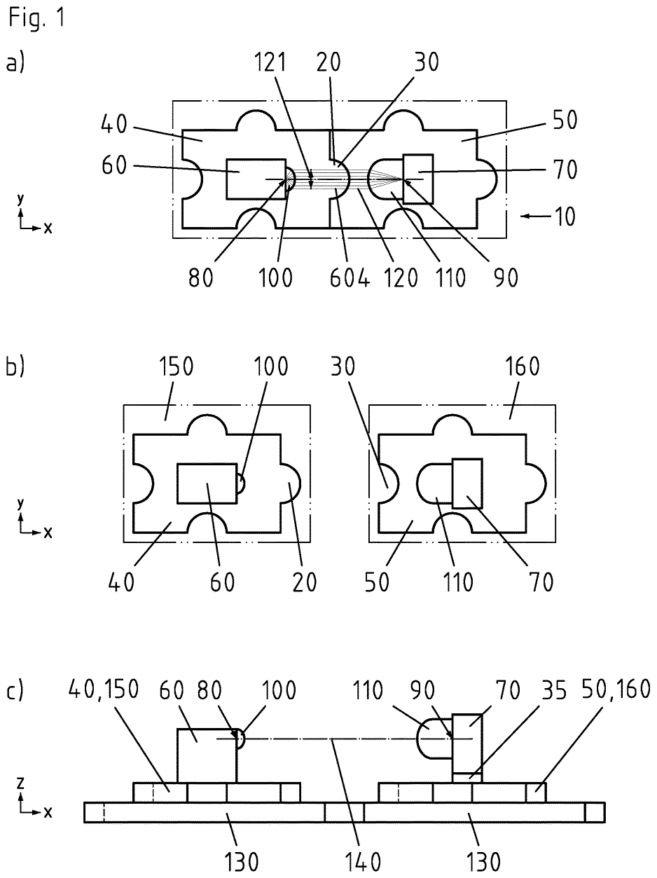

FIG. 1 shows a schematic representation of an exemplary embodiment of a micro-optomechanical system 10 according to the present invention in a top view (FIGS. 1a and 1b) and in a side view (FIG. 1c). In FIG. 1b, two different modules 150, 160 are shown as separate units which, as shown in Figure la, can be joined together to form the desired micro-optomechanical system 10. Each of the two modules 150, 160 has an optical component 60, 70, wherein each of the optical components 60, 70 is fastened on one of the carrier elements 40, 50, wherein each of the optical components 60, 70 has an optical coupling point 80, 90. The optical component 70 is applied to a plateau 35, which equalizes the height such that the optical axis 140 corresponds to the optical coupling points 80, 90. The two modules 150, 160 can be optically coupled with one another according to Figure la via the optical coupling points 80, 90 between beamforming elements 100, 110 via an optical axis 140 at an optical coupling point 604 between the two modules 150, 160, in this embodiment by using a collimated light beam 120, which has a defined beam diameter 121.

According to the invention, the optical coupling 604 results automatically by concatenating, clicking together, or plugging together the two modules 150, 160 along the optical axis 140, since each of the carrier elements 40, 50 has a connecting element 20, 30, wherein each connecting element 20, 30 has a self-centering joining element. In this case, the joining elements of each module 150, 160 fit with one another such that the carrier elements 40, 50 can be mechanically connected to one another detachably or non-detachably by using the joining elements. As schematically shown in Figures la and 1b, the joining elements structurally interlock in this case. As FIG. 1c shows, the modules 150, 160 of the present micro-optomechanical system 10 are moreover arranged on a common carrier plane 130.

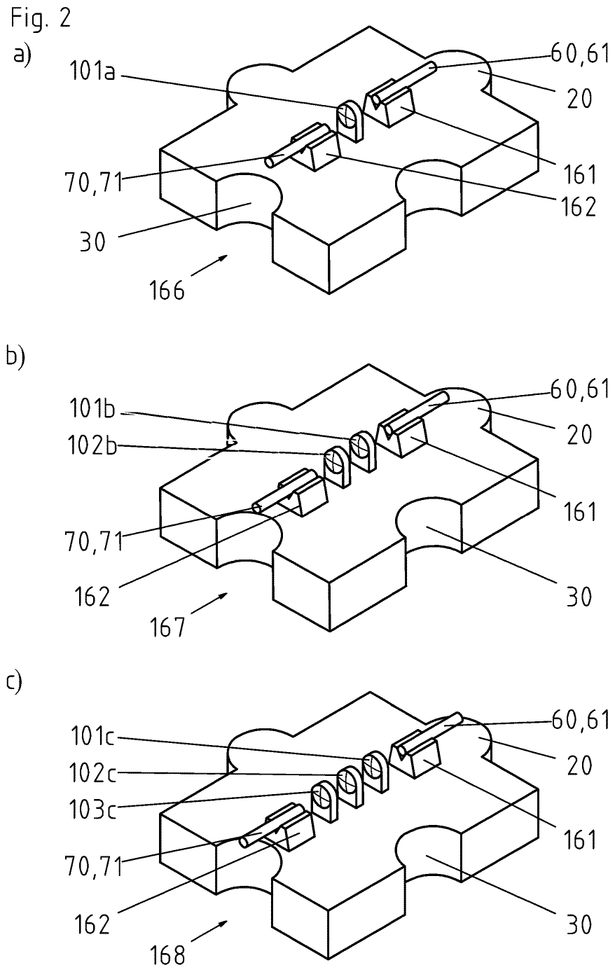

FIG. 2 shows a schematic representation of an optical assembly as a possible embodiment of a module 166, 167, 168 in a perspective view. An optical coupling within the module 166, 167, 168 is shown, which optically couples a mounted monomode fiber 61 with a second mounted monomode fiber 71, each of which has a diameter of 125 μm. Between two self-centering receptacle elements 161, 162 embodied as clamping devices, in each of which a glass fiber 61, 71 is introduced as the optical component 60, 70, the at least one beamforming element is located, which is embodied in FIG. 2a as a single optical lens 101a, in FIG. 2b as a lens system made up of two optical lenses 101b, 102b, and in FIG. 2c as a lens system made up of three optical lenses 101c, 102c, 103c. Both the optical lenses 101a, 101b, 101c, 102b, 102c, 103c shown and the receptacle elements 161, 162 each form a three-dimensional structure which is contiguous in a simple manner.

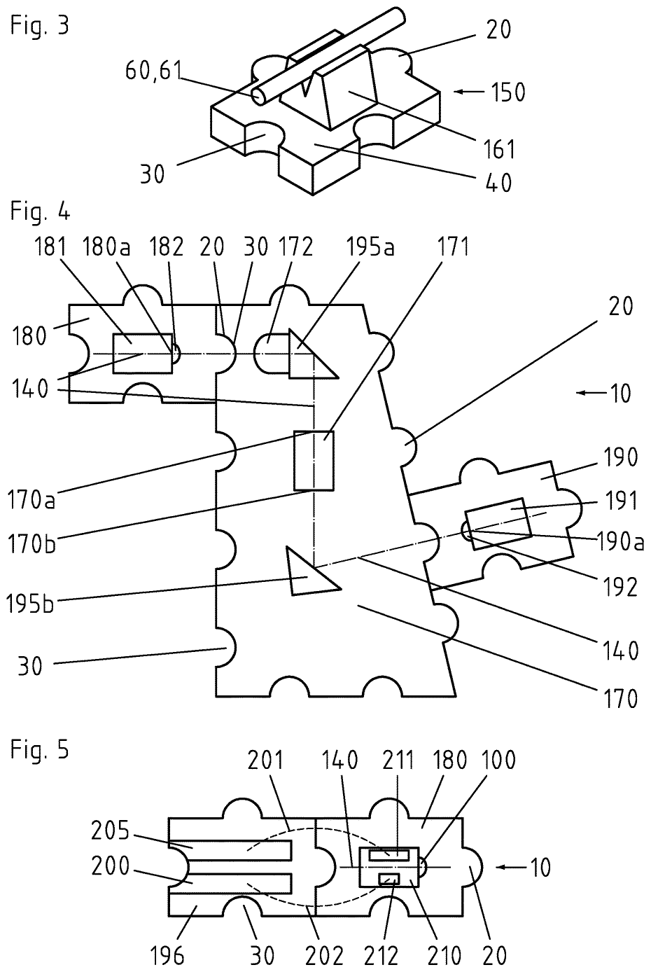

FIG. 3 schematically shows a perspective view of a preferred embodiment of a module 150, which comprises the self-centering receptacle element 161, which is configured in particular for accommodating cylindrical optical components 60, preferably a glass fiber 61. In contrast to FIG. 2, the optical assembly of the module 150, comprising a receptacle device 161 and a glass fiber 61, is embodied as a single receptacle device 161 for the glass fiber 61 and is used in the exemplary embodiment in FIG. 3 only to accommodate a single mode fiber 60, 61.

FIG. 4 shows a schematic representation of a further exemplary embodiment of the micro-optomechanical system 10 according to the present invention in a top view. This exemplary embodiment comprises three carrier elements 170, 180, 190, on each of which at least one optical component 171, 181, 191 is applied, which have the beamforming elements 172, 182, 192, wherein an optical connection of two of the optical components 171, 181, 191 is present at each of the optical coupling points 170a, 170b, 180a, 190a. The carrier elements 180, 190 are each mechanically connected to the carrier element 170 by using connecting elements 20, 30 which fit with one another and are identical to one another. The carrier elements 170, 180, 190 moreover have further identical connecting elements 20, 30, by which further carrier elements can be coupled onto one of the carrier elements 170, 180, 190. As can be seen from FIG. 4, the carrier element 170 has a size which deviates from the size and shape of the carrier elements 180, 190, which are each embodied in a preferred standard size and standard shape. Alternatively or additionally, it is also possible to select different horizontal or vertical geometries (not shown) for the carrier elements 170, 180, 190, so that an angle can result in a horizontal plane between preferred optical axes 140 of the modules 170, 190. Furthermore, the micro-optomechanical system 10 schematically shown in FIG. 4 has the beamforming elements 195a, 195b, which are embodied here as an optical deflection element; as a deflecting element 195a within the beamforming element or as a deflecting element 195b outside the beamforming element; however, further embodiments of the beamforming elements 195a and 195b are possible. The optical component 171 is embodied here so that it can be inserted into the beam path of the optical axis 140.

FIG. 5 shows a schematic representation of a further exemplary embodiment of the micro-optomechanical system 10 according to the present invention in a top view, which comprises the two carrier elements 180, 196. While an edge-emitting laser chip (distributed feedback laser; DFB) 210 is applied to the carrier element 180 by using a receptacle element (not shown), two conductor tracks 200, 205 are located on the carrier element 196, which are configured for electrically contacting the micro-optomechanical system 10. Alternatively (not shown), a surface-emitting laser chip can be used, which is arranged obliquely or decouples a beam parallel to the module surface by using a lens. According to the illustration in FIG. 4, electrical connections in the form of wire bonds 201, 202 are provided between the conductor tracks 200, 205 and contact pads 211, 212 configured for electrically contacting the laser chip 210.

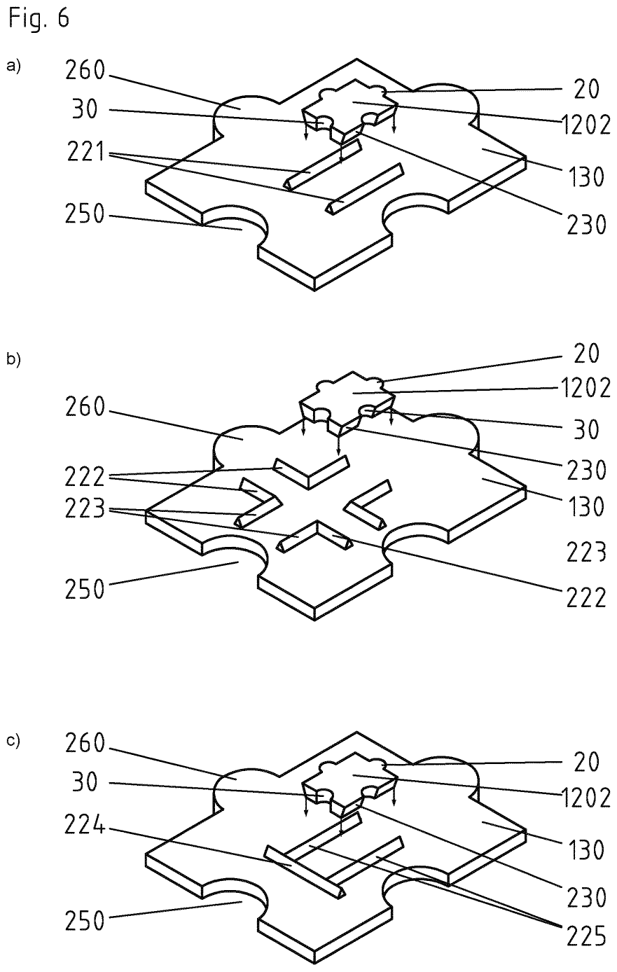

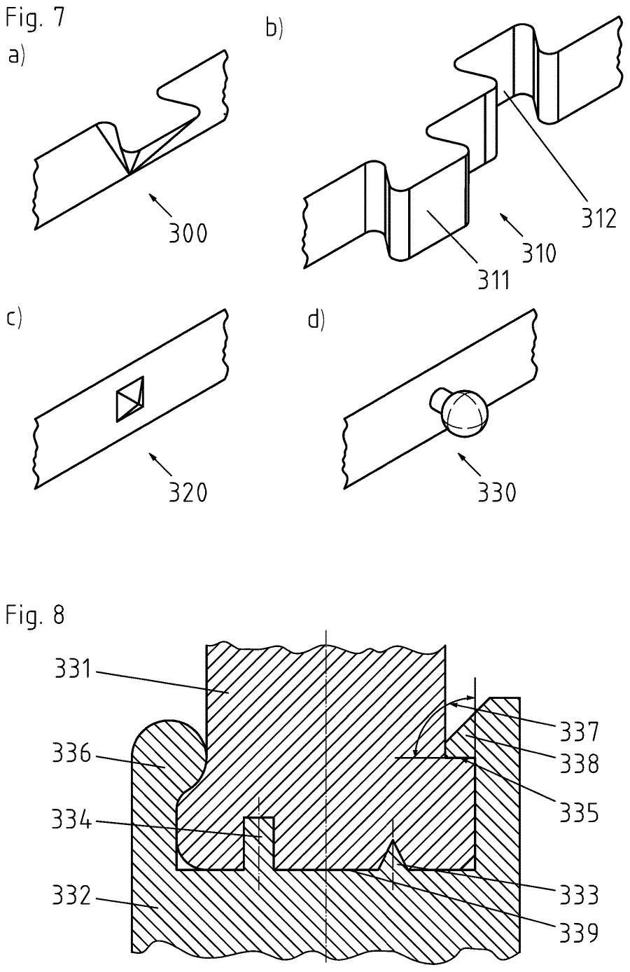

FIG. 6 shows three schematic representations of an exemplary embodiment for an application of a module 1202 equipped with no optical component on the carrier plane 130. The carrier plane 130 is configured in this case by using a self-centering receptacle element 221, 222, 223, 224, 225 to attach the module 1202 on the carrier plane 130, wherein the module 1202 has receptacle elements 230 and 231 fitting thereto. For this purpose, the receptacle element schematically shown in FIG. 6a comprises two elements 221 having receptacle elements embodied in one direction having a horizontal degree of freedom, in FIG. 6b comprises two elements 222 and 223 each having receptacle elements embodied in two directions for two one-dimensional degrees of freedom, and in FIG. 6c comprises elements 224, 225 having receptacle elements embodied in one direction for a one-dimensional degree of freedom with a stop, which are suitable for positioning, orienting, and fixing the module 1202 in relation to the carrier plane 130. The fixing can in this case comprise a detachable or non-detachable fastening of the module 1202 on the carrier plane 130. Moreover, the carrier plane 130 schematically shown in FIG. 6 is equipped with connecting elements 250, 260, to attach further carrier planes to the carrier plane 130. Many modules can preferably be housed on the carrier plane 130. The module 1202 fastened on the carrier plane 130 can in turn have connecting elements to at least one further carrier plane (not shown).

FIG. 7 shows schematic perspective views of exemplary embodiments of self-centering joining elements 300, 310, 320, 330 on the carrier elements 40, 50 of modules. The joining elements 300, 310, 320, 330 depicted in FIG. 7 preferably occur in pairs, in order to act accordingly as element to be joined and the receptacle provided for this purpose on one side or one side in each case of a module. Further embodiments (not shown) are conceivable, however, in particular a repeated embodiment. Furthermore, a positioning bevel 1108 in the form of a mounting ramp or step can represent an embodiment of a joining element.

FIG. 7a shows the self-centering joining element 300, which is embodied as tapering in the vertical direction, in particular to adopt both a vertically and also horizontally position-giving function, and also to be separable more easily from the residual carrier layer in a three-dimensional structuring method by way of a continuous edge produced on the lower side, which represents a cutting edge for defined cutting of the module out of a residual carrier layer. Furthermore, in a receptacle element embodied inversely to the shape of the connecting element 300, a height stop is defined by the undercut vertical direction, via which the height of the carrier elements to be joined can be set.

FIG. 7b shows the self-centering joining element 310, which has a so-called “2.5-dimensional” structure. The joining element 310 shown here comprises a one-sided arrangement in pairs of receptacle elements 311, 312, which better compensates a horizontal angle error of two modules connected to one another and oriented in relation to one another than using one joining element. This number can be increased arbitrarily. In the 2.5-dimensional embodiment, the base surface can be used as a stop for height definition.

FIG. 7c shows the further self-centering joining element 320, which has additional undercut structures configured, in conjunction with the joining elements 300 or 310, to also secure the carrier elements of the modules in the vertical direction in combination with a further fitting joining element against depositioning.

FIG. 7d shows a further self-centering joining element 330, which has double undercut structures configured both to secure the carrier elements of the modules in the vertical direction against depositioning, and also to secure two joined units against horizontal pulling apart. A structure inverse thereto (not shown) can be open on top in order to insert the receptacle element from above into the connecting element.

FIG. 8 schematically shows a detail view of two joined elements in a sectional view, in particular for connecting two carrier elements 331, 332. Alternatively, FIG. 8 can show the connection of an optical component and/or an electronic component to a carrier element and/or a carrier plane. Two different embodiments are shown on the left and right of the centerline, separated by the centerline. The positioning transverse to the joining direction is defined via structures 333 and 334 in the form of plug and coupling. Here 333 is embodied as a pyramid or triangle structure, 334 as a cylinder structure; further shapes are possible, however. The positioning in the joining direction is defined via a location of structure surfaces 339, which are mechanically pressed against one another. For this purpose, two undercut surface structures 336, 338 are used in the joining direction. The surface structures 336, 338 are preferably designed so that they can be expanded and/or stretched and/or spread outward from the centerline elastically and/or elastic-plastically during a joining procedure and lock in the undercut final position. The surface structure 336 is embodied having a homogeneous transition and therefore as a better detachable connection. In contrast, the surface structure 337 has a sharp undercut edge, which makes mounting more stable, but obstructs detaching the connection. The larger the angle 337 is set, the sharper is an undercut structure surface 335 of the structure surface 339 and therefore the mounting becomes more stable and more difficult to detach.

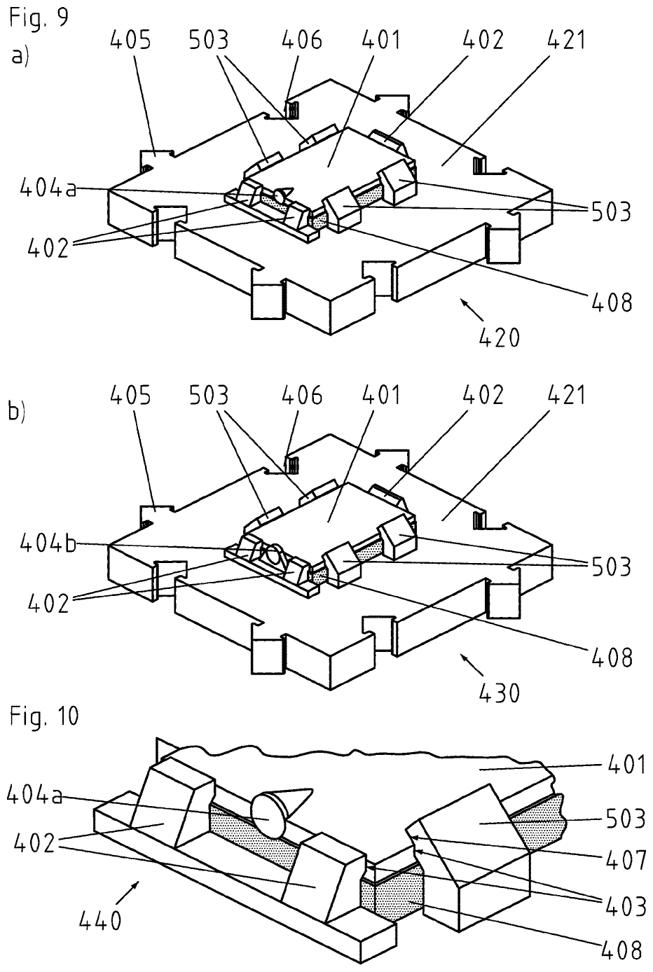

FIG. 9 shows an embodiment of a chip-integrating module 420, 430 in a perspective view. An optical assembly, comprising a laser chip 401, receptacle elements 402, hold down device 503, and beamforming elements 404a and 404b is located in each case on a carrier element 421. During the mounting, the laser chip 401 is positioned and inserted into a hold down device 503 and the receptacle elements 402, and the laser chip 401 can then be readjusted. Defined edges and surfaces are introduced onto or into the surface of the laser chip 401 for positioning, on which planar stops matched thereto on the carrier element 421 are applied for mechanical positioning, which flatly exactly position the laser chip 401 translationally and rotationally. The surface pair used for positioning the laser chip 401 is produced together therewith in this case and is embodied in the form of deep etches having vertically smooth edges. Further modules, in particular carrier elements, can be connected exactly positioned by joining by the joining elements 405, 406 of the carrier element 421. An optical axis for coupling between both modules can be defined in this way. This is defined in this exemplary embodiment by the beamforming element 404a, 404b and optical coupling points formed thereby and aligned accordingly. The beamforming element 404a, 404b manipulates the light here such that it can be coupled on the joined module into a further optical component. Alternatively (not shown), at least one marking on the carrier element 421 can be used for positioning and aligning the laser chip 401. Outside the deep-etched area, the laser chip 401 has a rough undefined sawn edge 408, which cannot be used as a positioning surface due to inadequately defined geometry in shape and planarity.

FIG. 9a shows an embodiment of the module 420, on which a lens was produced on the laser chip 401 as the beamforming element 404a by using a micro-lithographic structuring method.

FIG. 9b shows an embodiment of the module 430 having a lens as the beamforming element 404b in the form of a three-dimensional structure which is contiguous in a simple manner, and was produced as part of the optical assembly by using a three-dimensional structuring method, in particular by using a replication, together with the volume of the carrier element 421. The lens is designed such that it touches the coupling point of the optical output of an edge-emitting laser chip (distributed feedback laser; DFB). Alternatively (not shown), a surface-emitting laser chip can be used, which is arranged obliquely or decouples a beam parallel to the module surface by using a lens. Furthermore, it is possible to fill the intermediate space between the laser chip 401 and the lens using a further transparent material.

FIG. 10 shows a detail 440 from FIG. 9a in a perspective view having the receptacle elements 402, the hold down devices 503, the laser chip 401, and the beamforming element 404a. The receptacle elements 402 and the hold down devices 503 have surfaces having technical functionality of a receptacle element in the form of a mechanical stop, which form a pair by contact and position the laser chip 401. A pairing counter surface on the laser chip 401 in the form of deep etches is used as the receptacle element 403 in the form of a mechanical stop, is produced together therewith, and forms a defined surface. Outside the deep-etched area, the laser chip 401 has a rough undefined sawn edge 408, which cannot be used as a positioning surface due to inadequately defined geometry in shape and planarity. The hold down devices 503 inclined at an angle 407 hold the laser chip 401 in position and press it vertically downward into its position defined by the positioning elements and moreover prevent detaching, tilting, pivoting, and shifting of the laser chip 401.

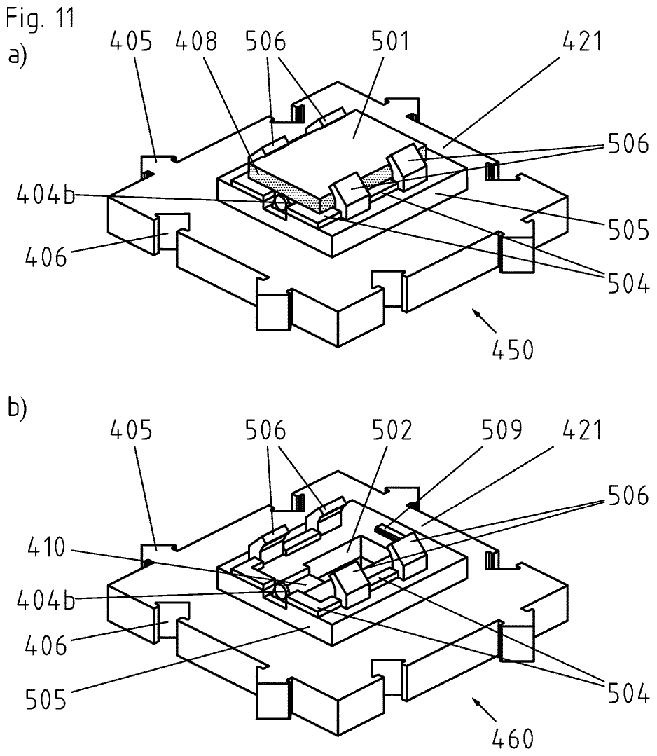

FIG. 11a shows, analogously to FIG. 9b, an embodiment of a chip-integrating module 450 in a perspective view. The optical assembly, comprising a laser chip 501, receptacle elements 504, hold down devices 506, and the beamforming element 404b, is located on the carrier element 421. In contrast to FIG. 9a, the laser chip 501 is mounted upside down, oriented toward the upper side of the carrier element 421. Furthermore, the laser chip 501 is applied to a plateau 505 in order to define the height of the optical axis. FIG. 11a represents a further exemplary embodiment analogous to FIG. 9; the lens as the beamforming element 404b can be produced together with the volume of the carrier element 421 and the optical assembly and/or by a micro-lithographic method directly on the laser chip 501. The laser chip 501 is preferably constructed such that its contacting points lie on the lower side of the laser chip 501 and in particular are accessible from above with an upside-down mounting.

FIG. 11b shows the carrier element 421 with optical assembly shown in FIG. 11a before the mounting of the laser chip 501 in a perspective view as a chip holding module 460 without chip. The optical assembly comprises the receptacle elements 504, 509, the hold down devices 506, the plateau 505, and the beamforming element 404b. Furthermore, it can be seen that the carrier element 421 and the plateau 505 have an opening 502 to make components accessible from the lower side of the laser chip 501. Furthermore, the optical assembly can have recesses 410 for free beam guidance and for enabling a contactless mounting.

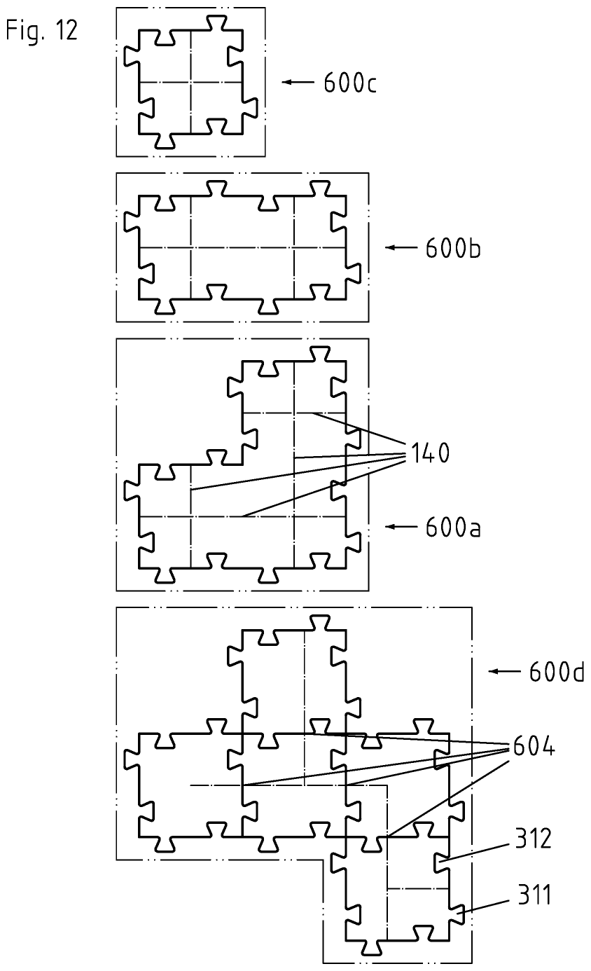

FIG. 12 shows a schematic embodiment of a micro-optomechanical system in a top view, having individual modules 600a, 600b, 600c of different sizes and a module group 600d having five individual modules joined to one another. The receptacle elements 311, 312 of the carrier elements repeat at an equal distance to one another, due to which the micro-optomechanical system can be expanded by joining further modules, in particular further carrier elements. The possibility results due to the above-mentioned 1 dB positioning tolerance of defining optical axes 140 for optical coupling 604 of individual modules and in this way exactly matching at least two modules to one another by the respective optical assembly and connecting them to one another by mutual joining. The optical axes 140 depend in their location and orientation on the respective optical assembly of two modules to be matched to one another.

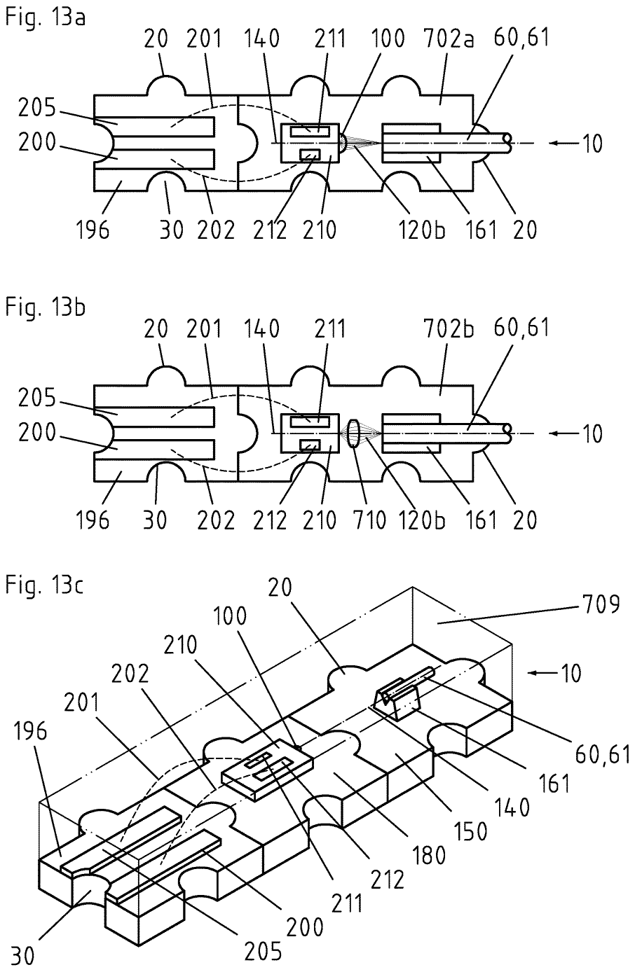

FIG. 13a shows a schematic design of the micro-optical system 10 in a top view, comprising the carrier element 196 and a chip module 702a. Analogously to FIG. 5, conductor tracks 200, 205 made of an electrically conductive material are located on the carrier element 196, which are electrically connected to the contact points 211, 212 of a laser chip 210 by using wire bonds 201, 202. An edge-emitting laser chip in a mount (not shown) and a receptacle element 161 for the light waveguides 60, 61 are located on the laser chip module 702a. In this embodiment, joining a separate module for accommodating 150 a glass fiber 60, 61 is omitted and they are integrated directly into the carrier element 180. The tolerance of the joining is dispensed with in this way, which can increase the positioning accuracy and therefore the coupling efficiency. A beamforming element 100 at the output of the laser chip 210 is pressed directly onto its surface and formed such that this light decoupled from the laser chip 210 is focused and coupled as a non-collimated light beam 120b directly into the glass fibers 60, 61. This embodiment can be supplemented and/or expanded by one or more further lenses.

FIG. 13b shows a further schematic design of the micro-optical system 10 in a top view, comprising the carrier element 196 and the chip module 702b. In contrast to FIG. 13a, the beamforming element 710 is integrated into the volume of the chip module 702b and is replicated together therewith.

FIG. 13c shows a further schematic design of the micro-optical system 10 in a perspective view, comprising the carrier element 196, a chip carrier module 180, and a glass fiber holder module 150. In contrast to FIG. 13a, the glass fiber holder module 150 is embodied separately and joined on the chip carrier module 180. Furthermore, the complete micro-optomechanical system 10 is filled using a material 709 which shields the micro-optomechanical system 10 to the outside, fixes the components at the same time, and reduces losses in the beam path between the optical components and/or the beamforming components. Furthermore, this filled form can be embodied (not shown) such that it enables easy attachment to existing devices or systems.

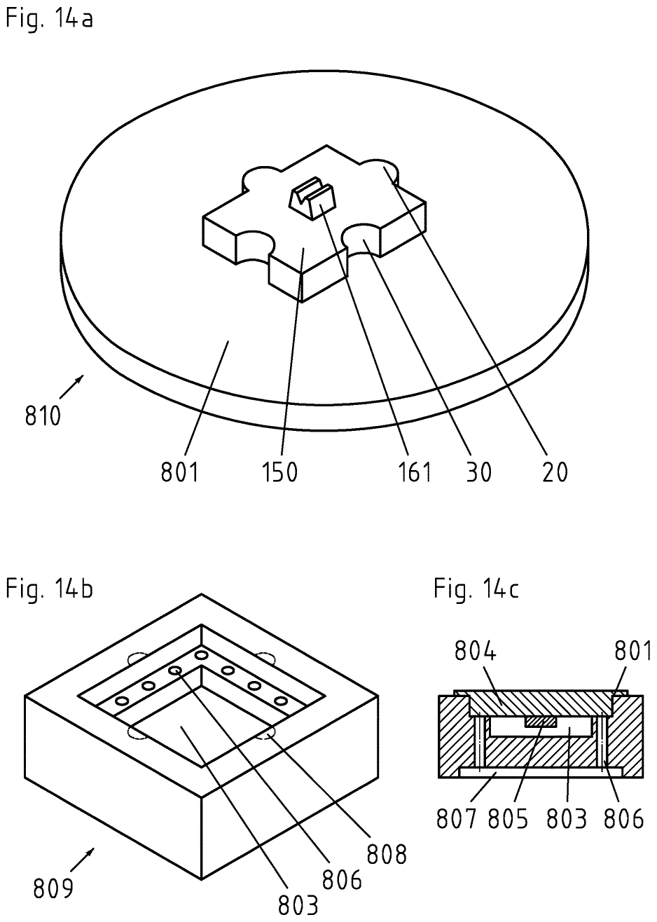

FIG. 14a schematically shows a perspective view of a preferred embodiment of a module 150, which comprises the self-centering receptacle element 161, which is configured in particular to accommodate cylindrical optical components 60, preferably a glass fiber 61. The module 150 is applied to a residual carrier layer 801, which arises during a replication procedure and which has to be removed in order to achieve a defined height of the module 150, so that the optical axes can vertically correspond while maintaining the 1 dB positioning tolerance.

FIG. 14b shows a schematic representation of a mount 809 for removal of the residual carrier layer 801 arising during the replication procedure. To ensure efficient optical coupling, a uniform module height with respect to the height of the optical axis and therefore the carrier elements having a height tolerance while maintaining the 1 dB positioning tolerance is necessary. To ensure this, the residual carrier layer 801 accordingly has to be removed. For this purpose, the module including the residual carrier layer 801 can be laid upside down in a device 809, in which the residual carrier layer 801 is accessible from above and can be removed. In the upside-down mounting of the replicated module, it has to be ensured that the optical assemblies 805 are not damaged, because of which these areas are left out by a recess 803 in the form of a trough, so that the module can only rest on its outer edge configured for this purpose. The module can be suctioned on from below and held in position through openings 806 in the edge area of the mount, so that the module cannot shift during the processing process. A depression can be used as a distribution chamber 807 on the lower side of the mount 809 for a negative pressure distribution. For even more accurate positioning of the modules, positioning elements, in particular an inverse opening or an attachment in the form of the receptacle elements 808, can be incorporated into the mount 809. In the embodiment shown here, the upper side of the mount 809 applies as the height to be set, which represents the lower side of the module at the same time, up to which the residual carrier layer 801 is removed. Preferably hot stamping or micro-injection molding can be used as the three-dimensional structuring method. The holes for suctioning on the module have to meet a plannable surface on the upper side of the carrier elements here, so that the vacuum can be maintained. An outer edge area on the carrier elements which cannot be provided with optomechanical assemblies results therefrom. In micro-injection molding or hot stamping, a so-called trim can remain because of the process which, in particular in the form of a residual carrier layer 801, can preferably be removed using a machining, cutting, or abrading method. Alternatively, a residual carrier layer of a defined height (not shown) can be accommodated in the target shape and in this way can form a plateau.

FIG. 14c shows a schematic sectional view of the device 809 for postprocessing and removing the residual carrier layer 801. A replicated module 804 is shown on a residual carrier layer 801 having the optical assembly 805 on the residual carrier layer 801, which lies in the recess 803 for the contactless mounting of the optical assembly 805. The module is suctioned on by negative pressure for stable mounting during the processing procedure. This negative pressure reaches the edge area of the module via the distribution chamber 807 through holes or openings 806, where it is thus firmly mounted. Subsequently, the residual carrier layer 801 can be removed to a defined height.

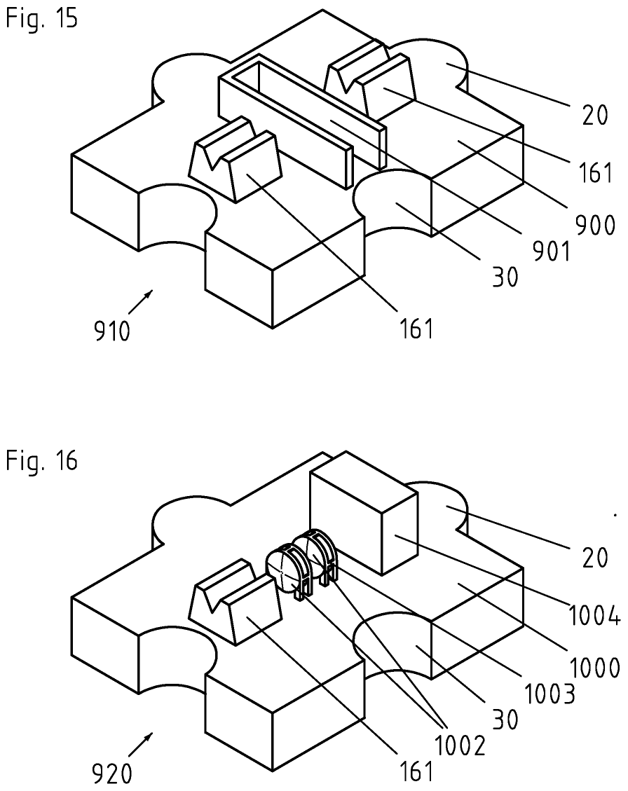

FIG. 15 shows a schematic design of a module 910, which has a carrier element 900 configured to accommodate three components, preferably two light waveguides in the form of glass fibers 60, 61, which are accommodated by the two receptacle elements 161 and in the optical axis of which a further component can be mounted in the receptacle element 901, in particular a filter or a micro-fluid guiding chip. The receptacle element 901 can exert an additional beamforming or beam-manipulating function due to its shape, preferably a beam expansion and/or focusing and/or beam deflection. Furthermore, the module can also include further beamforming elements. All receptacle elements can in turn have a positioning and fixing function. It is likewise possible to embody the receptacle element 901 having degrees of freedom, in particular restricted or only in one direction, so that one or more mounted components are displaceable.

FIG. 16 shows a schematic embodiment of a module 920 for optical coupling of two optical components. The optical assembly comprises a receptacle element 161, optical components in the form of a lens system 1002 comprising two by two lenses, and a further optical component 1004, which can be only partially produced together with the carrier element 1000 in one step. Due to the high aspect ratios of the lenses in the lens system 1002, these cannot be replicated and moreover require further support structures 1003 because of the structure between the lenses of the lens system 1002, which require a three-dimensional, not simply contiguous form. This has the result that the carrier element 1000 is preferably produced together with the receptacle element 161 and the receptacle element (not shown) of the optical component 1004 and the lens system 1002 is subsequently produced by using another micro-structuring method. In this case, markings (not shown) on the surface of the carrier element 1000, which are in particular embodied as crosses, can also be used to orient the downstream micro-structuring method.

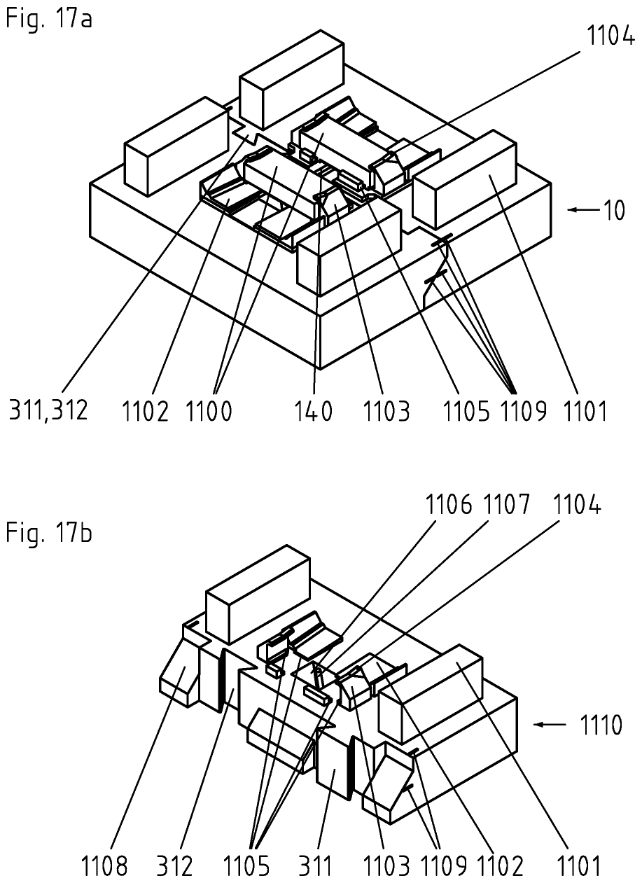

FIG. 17a shows a schematic design of the micro-optomechanical system 10 for coupling two chips 1100 in a perspective view. The optical assembly of the module 1110 comprises mounts 1101 for upside-down mounting of the system, pre-positioning elements 1102 for each chip 1100 in the form of a ramp having insertion bevels, which pre-positions each chip 1100 in direction and rotation in relation to its target final position and via which each chip 1100 can be shifted into its final position, hold down devices 1103 having an applied receptacle bevel 1104 for sliding in each chip 1100, receptacle elements 1105, and measurement markers 1109. The receptacle elements 1105 in the lower area of the optical assembly form contact surfaces for positioning at the points of deep-etched edges on each chip 1100, in order to position these horizontally in each case and press them into position or hold them there via the hold down devices 1103. The optical assembly is designed for the optical axes 140 of the two chips 1100 such that the optical axes 140 align. The insertion bevels can in particular be used to achieve a position-finding movement with defined final position or final positions. Furthermore, connecting elements 311, 312 are shown.

FIG. 17b shows a schematic design of the module 1110 shown in FIG. 17a in a perspective view. In contrast to FIG. 17a, only the module 1110 without chip 1100 is shown. The optical assembly comprises mounts 1101 for upside-down mounting of the system, the prepositioning elements 1102 for each chip 1100 in the form of a ramp having insertion bevels, which pre-position each of the chips 1100 in direction and rotation in relation to its target final position and via which each chip 1100 can be pushed into its final position, hold down devices 1103 having an applied receptacle bevel 1104 for sliding in the chips 1100, receptacle elements 1105, and measurement markers 1109. Via the pre-positioning elements 1102 in the form of the ramp, each chip 110 to be mounted can slide and/or be mounted and/or be pressed, preferably by receptacle bevels, into its defined final position. Furthermore, connecting elements to a further module in the form of a positioning bevel 1108 and connecting elements 311, 312 are shown, as are measurement markers 1109 in the form of lines. Furthermore, the module 1110 has an opening 1106 on the lower side in order to enable accessibility to the chips 1100, for example for a fiber 1107 which is led through.

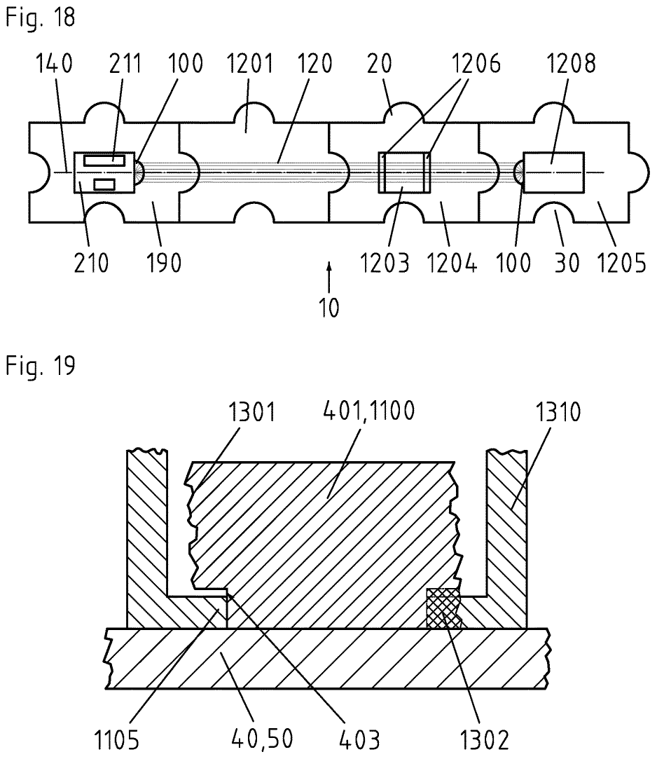

FIG. 18 shows a schematic representation of a further exemplary embodiment of the micro-optomechanical system 10 according to the present invention in a top view, which comprises the four carrier elements 190, 1201, 1204, 1205. While an edge-emitting laser chip 210 is applied to the carrier element 190 by using a receptacle element (not shown), no optical components are located on the carrier element 1201; this module is used as a space holder or spacer. An optical element 1203 is arranged on the carrier element 1204. The beamforming element 100 produced on the laser chip 210 collimates the beams along the optical axis 140 here until they are focused by the beamforming element 100 on module 1205 such that they are coupled into an optical component applied to the module 1205, for example in the form of a photodiode 1208. The optical element 1203 comprises two beamforming elements 1206 in this case, which are attached to a mount and can be configured to equalize index differences in relation to the optical component 1203, to obtain a collimation, or to be used as filters.

FIG. 19 shows a schematic section through a laser chip mounted on a carrier element 40, 50. The cross-section of the laser chip 401, 1100 used as the optical component can be seen, which has a rough and undefined sawn edge 1301, which cannot be used for positioning. Furthermore, smooth edges are shown which are produced with the chip itself, preferably by a deep etching method. In this way, the volume designated by 1302 was removed and forms a receptacle element 403 in the form of a defined edge or surface in the form of a mechanical stop, on which the laser chip 401, 1100 is positioned by stopping on the positioning elements 1105, 1310.

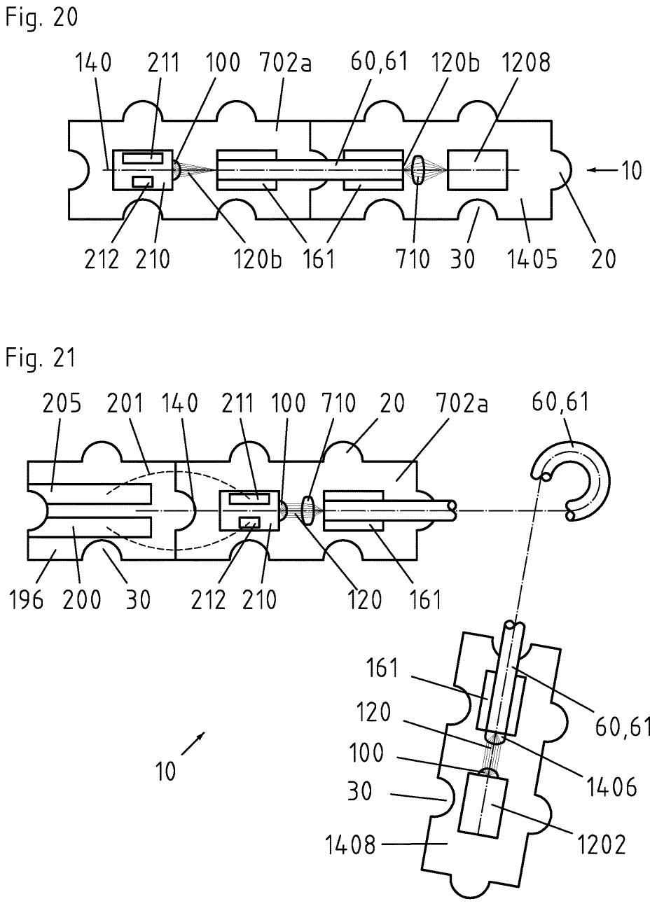

FIG. 20 shows a schematic design of the micro-optical system 10 in a top view, comprising the carrier elements 702a and 1405. Analogously to FIG. 13a, an edge-emitting laser chip 210 in a mount (not shown) and a receptacle element 161 having an introduced light waveguide 60, 61 are located on the laser chip module 702a. A receptacle element 161 having an introduced light waveguide 60, 61, a beamforming element 710, which is introduced into the volume of the chip module 1405, and an optical component 1208 are located on the carrier element 1405. The light is focused and coupled from the laser chip 210 via the beamforming element 100 as a non-collimated light beam 120b directly into the glass fibers 60, 61 and coupled at its output via a beamforming element 710 into the optical component 1208.

FIG. 21 shows the micro-optical system 10 schematically shown in FIG. 13a with the schematic expansion of a spatially separated carrier unit 1408 and the distinction of a further beamforming element 710, which couples a collimated light beam into the optical component 60, 61 embodied as a light waveguide. The module 1408 comprises a receptacle element 161 having an introduced light waveguide 60, 61, on which a beamforming element 1406 is arranged, which collimates light emerging from the optical component 60, 61 embodied as the light waveguide and couples it via a further beamforming element 100 into the optical component 1208.

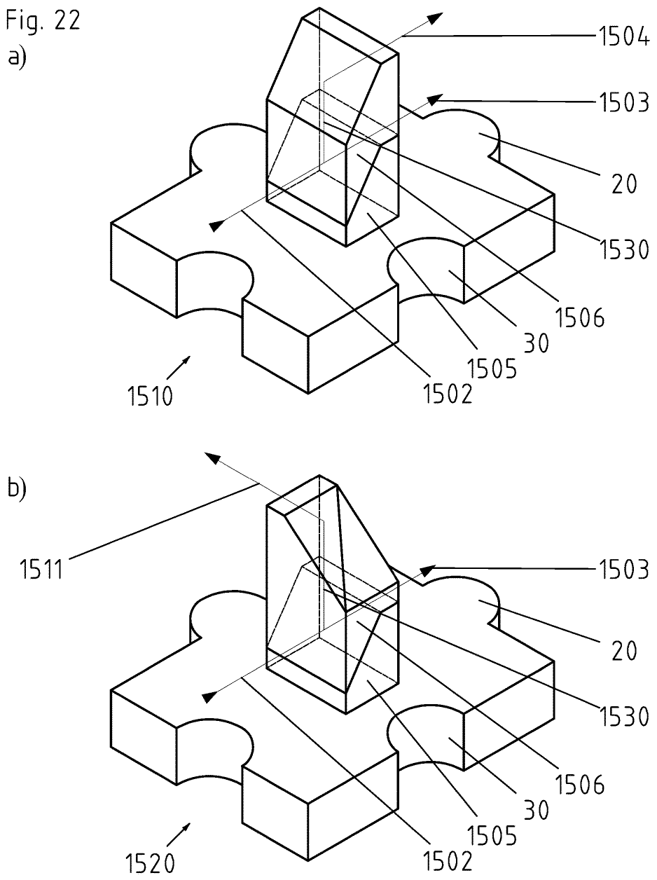

FIG. 22a shows a schematic view of an optical assembly as an embodiment of a module 1510 in a perspective view. The carrier element comprises a beam splitter 1505, which splits the light beam 1502 into a horizontal component 1503 and a vertical component 1530, as well as an optical deflection element 1506, which deflects a vertical light beam in a horizontal direction 1504, to thus generate a further plane of the light guidance.

FIG. 22b shows a further schematic view of an optical assembly as an embodiment of a module 1520 in a perspective view. In contrast to FIG. 22b, the light beam is decoupled here out of the optical deflection element 1506 in the second plane perpendicular 1511 to the incident light beam 1502.

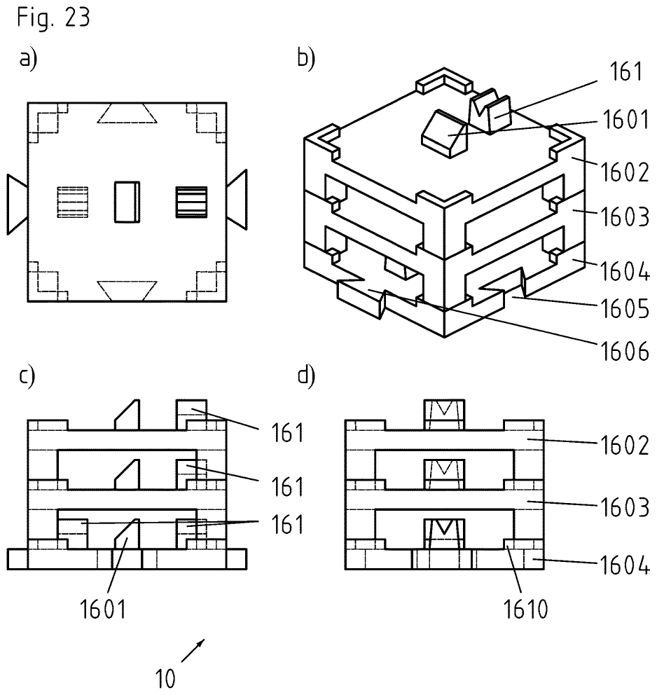

FIG. 23 shows a further schematic design of a micro-optical system 10 in a top view (FIG. 23a), in a perspective view (FIG. 23b), in a side view (FIG. 23c), and in a frontal view (FIG. 23d). The carrier units 1602, 1603, 1604 are stacked vertically in this case and conduct light via the vertical direction in various planes in order to create a three-dimensional character of the micro-optical system. For this purpose, the carrier elements have connecting elements 1605, 1606 and joining elements 1610, which can be vertically positioned and/or stacked. The light, in particular a light beam 1611 shown by way of example, can be distributed via beam splitters 1601 or further beamforming elements, in particular optical deflection elements, and coupled via receptacle elements 161 into a light waveguide (not shown).

### LIST OF REFERENCE SIGNS

10 micro-optomechanical system
20,30 connecting element
35, 505 plateau
40, 50 carrier element
60, 70 optical component
61,71 glass fiber
80,90 optical coupling point
100, 110 beamforming element
101a, 101b, 101c, 102b, optical lens
102c, 103c
120 collimated light beam
120b light beam
121 diameter of a collimated coupling light beam
130 carrier plane
140 optical axis
150, 160, 173 module
161, 162 receptacle element
166 module with fiber to fiber one lens coupling
167 module with fiber to fiber two lens coupling
168 module with fiber to fiber three lens coupling
170, 180, 190, 196 carrier element
170a, 170b, 180a, 190a optical coupling point
171, 181 191 optical component
172, 182, 192, 195a, 195b beamforming element
200, 205 conductor track
201, 202 wire bond
210 laser chip
211, 212 contact pad
221, 222, 223, 224, 225 connecting element between carrier element and carrier plane or carrier plane and carrier plane
230, 231 connecting element between carrier element and carrier plane or carrier plane and carrier plane
300, 310, 320, 330 self-centering joining element
311, 312 connecting element
331, 332 joining element
333, 334 structures in the form of plug and coupling
335 undercut structure surface
336 embodiment of an undercut joining device with transition
337 angle of an undercut surface without transition, as nondetachable embodiment
338 embodiment of an undercut joining device with sharp transition
339 outer surface as a stop for positioning the final position
401 laser chip
402 receptacle element of the optical assembly
403 receptacle element in the form of a mechanical stop
404a lens printed on chip
404b, 710 lens replicated together with carrier element
405, 406 joining element
407 hold down device of the optical assembly
408, 1301 uneven surface, in particular a sawn edge
410 mounting groove
420, 430, 450 design of a chip holder module
421 design of a carrier element
440 detail of a design of a chip holder module
460 design of a chip holder module without chip
501 laser chip, mounted upside down
502 opening in module/carrier element to lower side
503, 506 hold down device of optical assembly
504, 509 positioning elements, here stops of optical assembly
600a, 600b, 600c individual module
600d module group
604 optical coupling points between modules
702a design of a module with chip and fiber integration on a module, lens pressed onto chip
702b design of a module with chip and fiber integration on a module, lens fabricated with carrier element
709 material
710 beamforming element
801 residual carrier layer
803 recess for an optical assembly
805 optical assembly
806 opening (for vacuum)
807 (vacuum) distribution chamber
808 receptacle element
809 mount
804, 810 replicated module on residual carrier layer
900 carrier element for integration of a fluid chip
901 receptacle element for components
910, 920 embodiments of a module
1000 carrier element for fiber for fiber coupling
1002 lens system
1003 support structure
1004 optical component
1100 (laser) chip
1101 mount for upside-down mounting
1102 pre-positioning element
1103 hold down device
1104 insertion bevel
1105 receptacle element
1106 opening for accessibility from below
1107 (glass) fiber for passive measurement
1108 positioning bevel
1109 measurement marker
1110 design of a (chip holder) module
1201 carrier element without optical assembly
1202 module without optical assembly
1203 optical element
1204, 1205 design of a carrier element
1206 beamforming element
1302 volume removed by using deep etching
1310 positioning element
1405,1408 carrier element
1406 beamforming element
1510, 1520 design of a module/optical assembly
1505 optical component in the form of a beam splitter
1506 optical component in the form of an optical deflection element
1502, 1503, 1504 horizontal light beam
1511, 1530 vertical light beam
1601 beam splitter
1602, 1603,1604 carrier units
1605, 1606 connecting elements
1610 joining elements
1611 light beam

1. A micro-optomechanical system (10), comprising
at least two carrier elements, wherein each of the carrier elements has at least one connecting element, wherein each connecting element has at least one self-centering joining element or is designed as a self-centering joining element, wherein the joining elements fit with one another such that the carrier elements are mechanically connected to one another by using the joining elements ; and
at least two optical components, wherein each of the optical components is fastened on one of the carrier elements, wherein each of the optical components has at least one optical coupling point wherein at least one of the optical coupling points comprises at least one beamforming element produced by using a three-dimensional structuring method, and wherein an optical connection of the optical components is present at at least one optical coupling point.

2. The micro-optomechanical system of claim 1, wherein the at least one optical connection is present between at least two optical coupling points, wherein each of the at least two optical coupling points comprises at least one of the beamforming elements produced by using the three-dimensional structuring method.

3. The micro-optomechanical system of claim 1, wherein
the joining elements of the carrier elements are mechanically connected to one another by using a form fit.

4. The micro-optomechanical system of claim 1, wherein at least two carrier elements are connected to one another such that the at least two optical components and the at least one beamforming element lie on at least one common optical axis.

5. The micro-optomechanical system the claim 1, wherein at least one of the carrier elements is provided with at least one metallic layer as an electrical conductor track.

6. The micro-optomechanical system of claim 5, wherein
at least one of the carrier elements is fastened on
at least one carrier plane.

7. The micro-optomechanical system claim 1, wherein at least one of the carrier elements, the at least one optical component fastened thereon, and the at least one beamforming element are surrounded by an optically transparent medium which is solid at least in some areas.

8. The micro-optomechanical system of claim 1, comprising at least one first carrier element, one second carrier element, and one third carrier element, wherein the first carrier element is connected by using the connecting elements to the second carrier element and to the third carrier element, wherein the at least one optical component fastened on the first carrier element has at least one first optical coupling point and one second optical coupling point, wherein a first optical connection exists between the first optical coupling point and an optical coupling point of the at least one optical component fastened on the second carrier element, and concurrently a second optical connection exists between the second optical coupling point and at least one optical coupling point of the at least one optical component fastened on the third carrier element.

9. The micro-optomechanical system of claim 1, wherein at least one of the carrier elements has at least one further beamforming element, which is arranged on the carrier element or on an optical component fastened on the carrier element or is introduced into the carrier element or into an optical component fastened on the carrier element.

10. The micro-optomechanical system of the claim 1, furthermore comprising at least one positioning element, which is configured such that a position of at least one of the optical components on one of the carrier elements is defined by a substructure, wherein the substructure is produced by using the same method as the at least one of the optical components.

11. The micro-optomechanical system one of claim 1, furthermore comprising at least one further carrier element, on which none of the optical components is fastened and which does not comprise any of the beamforming elements.

12. A method for producing a micro-optomechanical system, comprising the following steps:
a) providing at least two carrier elements wherein each of the carrier elements has at least one connecting element, wherein each connecting element has at least one self-centering joining element or is designed as a self-centering joining element wherein the joining elements fit with one another such that the carrier elements are mechanically connectable to one another by using the joining elements ;
b) providing at least two optical components, wherein each of the optical components comprises at least one optical coupling point;
c) producing at least one beamforming element at at least one of the optical coupling points by using a three-dimensional structuring method;
d) fastening each optical component on one of the carrier elements and e) establishing an optical coupling of the optical components at at least one optical coupling point by using a mechanical connection of the carrier elements by the self-centering joining elements fitting with one another.

13. The method of claim 12, wherein the mechanical connection of the carrier elements takes place by using a form fit.

14. The method claim 12, wherein at least one of the carrier elements are is produced by using a three-dimensional structuring method.

15. The method of claim 12, wherein at least one beamforming element is produced by using the three-dimensional structuring method at each of the at least two optical coupling points.

16. The method of claim 12, wherein at least one of the optical components is produced by using a three-dimensional structuring method.

17. The micro-optomechanical system of claim 1, wherein the joining elements of the connecting elements are designed such that they can structurally interlock.

18. The micro-optomechanical system of claim 1, wherein the carrier elements are detachably or non-detachably connected to one another while maintaining shape and functionality.

19. The micro-optomechanical system of claim 5, wherein the carrier elements are connected to the at least one carrier plane or the at least two carrier planes are connected to one another detachably or non-detachably while maintaining shape and functionality.

20. The micro-optomechanical system of claim 5, wherein the carrier plane is provided with at least one metallic layer as an electric conductor track.
